(19) United States
(12) Patent Application Publication
(10) Pub. No.: US 2026/0084600 A1
(43) Pub. Date: Mar. 26, 2026

(54) VEHICLE SEAT AND METHOD FOR MANUFACTURING VEHICLE SEAT

(71) Applicant: TS TECH CO., LTD., Asaka-shi, Saitama (JP)

(72) Inventors: Yu ISHII, Tochigi (JP); Hiroshi TAKANOHASHI, Tochigi (JP); Akira MIYOSHI, Tochigi (JP)

(21) Appl. No.: 19/109,971

(22) PCT Filed: Nov. 14, 2023
(86) PCT No.: PCT/JP2023/040921

§ 371 Date: Mar. 7, 2025

Related U.S. Application Data
(60) Provisional application No. 63/425,757, filed on Nov. 16, 2022.
(60) Provisional application No. 63/476,453, filed on Dec. 21, 2022.

(30) Foreign Application Priority Data
Mar. 28, 2023 (JP) 2023-052404
Mar. 31, 2023 (JP) 2023-057048

(51) Int. Cl. B60N 2/70; B60N 2/68; B60N 2/72

(52) U.S. Cl. CPC B60N 2/7017; B60N 2/68; B60N 2/72

(57) ABSTRACT

Provided is a vehicle seat in which a pad member is prevented from being shifted and/or offset with respect to a support member. The vehicle seat includes a seat frame that serves as a skeletal frame, a support member provided on the seat frame and having a support surface facing upward, and a pad member supported on the support member and having a contact surface that is in contact with the support surface, wherein at least one of the support surface of the support member and the contact surface of the pad member has a plurality of protrusions formed thereon and protruding toward the other of the support surface and the contact surface.

### TECHNICAL FIELD

The present invention relates to an attachment structure for a vehicle seat.

### BACKGROUND ART

Patent Document 1 discloses a vehicle seat comprising a seat frame, a support member provided on the seat frame, a seat pad (pad member) supported by the support member, and a seat cover (outer skin) that covers the seat pad. The support member has a surface that can be in contact with the seat pad.

### PRIOR ART DOCUMENT(S)

### Patent Document(s)

Patent Document 1: JP2015-123321A

### SUMMARY OF THE INVENTION

### Task to be Accomplished by the Invention

The vehicle seat disclosed in Patent Document 1 involves a problem that, when an occupant is seated and a load caused by the occupant's weight is applied to the seat pad, the load is likely to cause the seat pad to be shifted and/or offset with respect to the support member.

This can lead to deformation of the seat pad, causing the vehicle seat to be uncomfortable for the occupant. The shifting of the seat pad can also decrease the stability of the vehicle seat for supporting the occupant. Furthermore, the deformation of the seat pad can cause the seat cover to form wrinkles, thereby damaging the appearance of the vehicle seat.

The present invention has been made in view of the problems of the prior art, and a primary object of the present invention is to provide a vehicle seat configured to prevent a pad member of the vehicle seat from being shifted and/or offset with respect to a support member.

### Means to Accomplish the Task

As a solution to the above-described task to be accomplished, an aspect of the present invention provides a vehicle seat (1) comprising: a seat frame (8) that serves as a skeletal frame; a support member (14) provided on the seat frame and having a support surface (22) facing upward; and a pad member (21) supported on the support member, the pad member having a contact surface (25) that is in contact with the support surface, wherein at least one of the support surface of the support member and the contact surface of the pad member has a plurality of protrusions (18, 47) formed thereon and protruding toward the other of the support surface and the contact surface.

In this configuration, each of the plurality of protrusions claws into (i.e., engages with) the pad member or the support member, which prevents the pad member from being shifted and/or offset with respect to the support member.

The vehicle seat may be further configured such that the plurality of protrusions (18) are formed on the support surface of the support member and protrude toward the contact surface of the pad member, and wherein the contact surface of the pad member has recesses (29) formed thereon that receive the corresponding protrusions.

In this configuration, the plurality of recesses formed on the pad member receive the corresponding protrusions formed on the support member, which enables each of the protrusions claws into the pad member in a more effective manner. This means that this configuration effectively prevents the pad member from being shifted and/or offset with respect to the support member.

The vehicle seat may be further configured such that the plurality of protrusions extend in a left-right direction of the vehicle seat, and wherein each of the plurality of protrusions has a first wire (38) embedded therein.

This configuration improves the durability of each of the protrusions.

The vehicle seat may be further configured such that the seat frame comprises: left and right side members (9) that are spaced apart from each other; and a plurality of second wires (43) that extend in the left-right direction and are connected to the left and right side members, and wherein the contact surface of the pad member has incisions (44) formed thereon to receive the corresponding second wires.

In this configuration, even when the vehicle seat has a simple structure, each of the plurality of second wires is engaged by the pad member, which prevents the pad member from being shifted and/or offset with respect to the support member.

The vehicle seat may be further configured such that the plurality of protrusions (47) are formed on the contact surface of the pad member and protrude toward the support member, and wherein the support member has a plurality of through holes (46) that extend therethrough to receive the plurality of protrusions.

In this configuration, the plurality of protrusions formed on the pad member are received in the corresponding recesses formed on the support member, which enables each of the protrusions to be caught in the pad member in a more effective manner. This means that this configuration effectively prevents the pad member from being shifted and/or offset with respect to the support member.

The vehicle seat may be further configured such that the plurality of protrusions comprise elongated protrusions extending along the support surface in at least two directions that are different from each other.

In this configuration, each of the plurality of protrusions is caught in the pad member in a more effective manner. This means that, even when a force is applied to the pad member such that the pad member horizontally would move in a predetermined direction, this configuration prevents the pad member from being shifted and/or offset with respect to the support member.

The vehicle seat may be further configured such that each of the plurality of protrusions has a tapered cross-sectional shape that tapers upward.

This configuration facilitates the assembly work to have the plurality of protrusions received in the corresponding recesses.

The vehicle seat may be further configured such that the plurality of protrusions are unevenly provided to be distributed in a part of the support surface of the support member.

This configuration prevents the pad member from being shifted and/or offset with respect to the support member in a more effective manner.

The vehicle seat may be further configured such that the plurality of protrusions are integrally formed with the corresponding recesses.

In this configuration, while each of the plurality of protrusions is received in the corresponding through hole in the support surface of the support member, each of the plurality of protrusions is caught in the support member in a more effective manner. As a result, the pad member is prevented from being shifted and/or offset with respect to the support member.

As a solution to the above-described task to be accomplished, another aspect of the present invention provides a method for manufacturing a vehicle seat (1), wherein the vehicle seat comprises a seat frame (8) that serves as a skeletal frame, a support member (14) provided on the seat frame, and a pad member supported on the support member, and wherein the support member has a plurality of through holes (46) that extend therethrough, the method comprising a step of molding (FIG. 15) in which the pad member and the support member are molded together as one piece, and wherein, in the step of molding, parts of the pad member are received in the corresponding through holes formed in the support member.

In this configuration, the plurality of through holes are formed in the support member and the pad member has the plurality of protrusions formed thereon, which receives the corresponding through holes in the support member. Furthermore, the contact surface of the pad member and the support surface of the support member are joined to each other. These features prevent the pad member from being shifted and/or offset with respect to the support member.

In recent years, environmentally friendly biomass urethane has been developed. Biomass urethane is a urethane foam that contains raw materials including renewable plant and other biomass resources. Cushion components made of biomass urethane (hereinafter also referred to as “first cushion components”) can be used in a variety of applications, such as vehicle seats, cushions, sofas, and door linings.

However, when a first cushion component is used in various applications, there is a problem that a rather large load applied to the first cushion component may cause significant deformation of the first cushion component (e.g. occurrence of sag of the cushion component). In particular, when a first cushion component is used at a position that comes into contact with a person, a large load caused by a person's weight can cause significant deformation of the first cushion component. In addition, when a first cushion component is used in interior parts of a vehicle (such as seats and door linings), the movement of the vehicle may cause even greater loads to be applied to the first cushion component, resulting in significant deformation of or damage to the first cushion component. Furthermore, when receiving a force from a moving component such as an inflatable/deflatable bag (specifically air cell), a first cushion component can deform more significantly.

Thus, another object of the present invention is to provide a seat cushion and a vehicle seat configured to prevent significant deformation of the cushion component made of biomass urethane.

As a solution to the above-described task to be accomplished, an aspect of the present invention provides a seat cushion comprising a first cushion component and one or more movable components. The first cushion component is made of biomass urethane. Each of the movable components is switchable between a first state and a second state that is different from the first state. At least one movable component included in the movable components is positioned to “avoid” the at least one movable component; that is, positioned such that boundaries of the at least one movable component do not touch the first cushion component.

In this configuration, the at least one movable component is positioned to avoid the at least one movable component; that is, positioned such that boundaries of the at least one movable component do not touch the first cushion component, which prevents significant deformation of the cushion component made of biomass urethane.

The seat cushion may be further configured such that the seat cushion further comprises a second cushion component that are less deformable than the first cushion components, and the movable component may be located in the second cushion component.

In this configuration, the movable components move within the second cushion component, which can prevent large deformation of the first cushion component.

The seat cushion may be further configured such that each of the movable components is a bag that inflates and deflates in the seat cushion by injection or release of air into or from the bag.

The seat cushion may be further configured such that the seat cushion has a seat surface for supporting a user, and at least part of the second cushion component is located between the seat surface and the first cushion component.

The seat cushion may be further configured such that the seat cushion serves as a seat where a user is seated, and comprises a base component, and left and right bulge components that more bulge out toward the user than the base component, wherein the first cushion component is positioned to avoid the user side surfaces of the left and right bulge components; that is, positioned such that boundaries of the first cushion component do not touch the user side surfaces of the left and right bulge components.

In this configuration, the first cushion component is positioned to avoid the user side surfaces of the left and right bulge components; that is, positioned such that boundaries of the first cushion component do not touch the user side surfaces of the left and right bulge components, which tend to receive large loads caused by the user's weight. As a result, the force applied to the user side surfaces of the bulge components is less likely to be transmitted to the first cushion component, which effectively reduces deformation of the first cushion component.

The seat cushion may be further configured such that the seat cushion serves as a seat where a user is seated, and comprises a base component, and left and right bulge components that more bulge out toward the user than the base component, wherein the first cushion component is positioned to avoid connection parts where the user side surfaces of the left and right bulge components are connected to a user side surface of the base component; that is, positioned such that boundaries of the first cushion component do not touch the connection parts.

In this configuration, the first cushion component is positioned to avoid the connection parts; that is, positioned such that boundaries of the first cushion component do not touch the connection parts, where stress tends to concentrate. As a result, the stress applied to the connection parts is less likely to be transmitted to the first cushion component, which effectively reduces deformation of the first cushion component.

The seat cushion may be further configured such that an entire surface of the first cushion component is covered with the second cushion component.

In this configuration, even when a load is applied to any position of the surface of the seat cushion, which means that the force applied to the seat cushion is less likely to be transmitted to the first cushion component, thereby effectively reducing deformation of the first cushion component.

The seat cushion may be further configured such that the seat cushion further comprises an air passage through which air flows, and the first cushion component is away from the air passage.

In this configuration, even when deformation occurs in a passage-embedded portion of the seat cushion where the air passage is formed and deformation is likely to occur, the first cushion component is less likely to be affected by the deformation of the passage-embedded portion. This further reduces deformation of the first cushion component.

The seat cushion may be further configured such that the seat cushion further comprises a heater, and the first cushion component is away from the heater.

In this configuration, heat from the heater is less likely to be transferred to the first cushion component, which means that the first cushion component is less affected by the heat from the heater.

The seat cushion may be further configured such that the seat cushion further comprises a notifying device for providing a notification to the user, and the first cushion component is away from the notifying device.

In this configuration, heat from the notifying device is less likely to be transferred to the first cushion component, which means that the first cushion component is less affected by the heat from the notifying device.

The seat cushion may be further configured such that the seat cushion further comprises a sensor for acquiring user's physical information, and the first cushion component is away from the sensor.

In this configuration, heat from the sensor is less likely to be transferred to the first cushion component, which means that the first cushion component is less affected by the heat from the sensor.

A second aspect of the present invention provides a seat cushion comprising a first cushion component and one or more movable components. The first cushion component is made of biomass urethane. Each of the movable components is switchable between a first state and a second state that is different from the first state. Each of the movable components has a maximum displacement section where, when the state is switched from the first state to the second state, the amount of displacement is maximized. The maximum displacement section of at least one movable component included in the movable components is positioned to avoid the first cushion component; that is, positioned such that boundaries of the maximum displacement section of at least one movable component do not touch the first cushion component.

In this configuration, the maximum displacement section of the at least one movable component is positioned to avoid the first cushion component; that is, positioned such that boundaries of the maximum displacement section do not touch the first cushion component, which prevents significant deformation of the cushion component made of biomass urethane.

A third aspect of the present invention provides a vehicle seat comprising the above-described seat cushion, a frame that supports the seat cushion, and an airbag device equipped with an airbag that can be deployed outside the seat cushion. The first cushion component is away from the airbag device.

This configuration reduces deformation of the first cushion component even when the operation of the airbag device causes a force which is applied to the seat cushion.

### Effect of the Invention

As described above, the present invention can be embodied as a vehicle seat (1) comprising: a seat frame (8) that serves as a skeletal frame; a support member (14) provided on the seat frame and having a support surface (22) facing upward; and a pad member (21) supported on the support member, the pad member having a contact surface (25) that is in contact with the support surface, wherein at least one of the support surface of the support member and the contact surface of the pad member has a plurality of protrusions (18, 47) formed thereon and protruding toward the other of the support surface and the contact surface.

In this configuration, each of the plurality of protrusions claws into (i.e., engages with) the pad member or the support member, which prevents the pad member from being shifted and/or offset with respect to the support member.

The vehicle seat may be further configured such that the plurality of protrusions (18) are formed on the support surface of the support member and protrude toward the contact surface of the pad member, and wherein the contact surface of the pad member has recesses (29) formed thereon that receive the corresponding protrusions.

In this configuration, the plurality of recesses formed on the pad member receive the corresponding protrusions formed on the support member, which enables each of the protrusions claws into the pad member in a more effective manner. This means that this configuration effectively prevents the pad member from being shifted and/or offset with respect to the support member.

The vehicle seat may be further configured such that the plurality of protrusions extend in a left-right direction of the vehicle seat, and wherein each of the plurality of protrusions has a first wire (38) embedded therein.

This configuration improves the durability of each of the protrusions.

The vehicle seat may be further configured such that the seat frame comprises: left and right side members (9) that are spaced apart from each other; and a plurality of second wires (43) that extend in the left-right direction and are connected to the left and right side members, and wherein the contact surface of the pad member has incisions (44) formed thereon to receive the corresponding second wires.

In this configuration, even when the vehicle seat has a simple structure, each of the plurality of second wires is engaged by the pad member, which prevents the pad member from being shifted and/or offset with respect to the support member.

The vehicle seat may be further configured such that the plurality of protrusions (47) are formed on the contact surface of the pad member and protrude toward the support member, and wherein the support member has a plurality of through holes (46) that extend therethrough to receive the plurality of protrusions.

In this configuration, the plurality of protrusions formed on the pad member are received in the corresponding recesses formed on the support member, which enables each of the protrusions to be caught in the pad member in a more effective manner. This means that this configuration effectively prevents the pad member from being shifted and/or offset with respect to the support member.

The vehicle seat may be further configured such that the plurality of protrusions comprise elongated protrusions extending along the support surface in at least two directions that are different from each other.

In this configuration, each of the plurality of protrusions is caught in the pad member in a more effective manner. This means that, even when a force is applied to the pad member such that the pad member horizontally would move in a predetermined direction, this configuration prevents the pad member from being shifted and/or offset with respect to the support member.

The vehicle seat may be further configured such that each of the plurality of protrusions has a tapered cross-sectional shape that tapers upward.

This configuration facilitates the assembly work to have the plurality of protrusions received in the corresponding recesses.

The vehicle seat may be further configured such that the plurality of protrusions are unevenly provided to be distributed in a part of the support surface of the support member.

This configuration prevents the pad member from being shifted and/or offset with respect to the support member in a more effective manner.

The vehicle seat may be further configured such that the plurality of protrusions are integrally formed with the corresponding recesses.

In this configuration, while each of the plurality of protrusions is received in the corresponding through hole in the support surface of the support member, each of the plurality of protrusions is caught in the support member in a more effective manner. As a result, the pad member is prevented from being shifted and/or offset with respect to the support member.

As a solution to the above-described task to be accomplished, another aspect of the present invention provides a method for manufacturing a vehicle seat (1), wherein the vehicle seat comprises a seat frame (8) that serves as a skeletal frame, a support member (14) provided on the seat frame, and a pad member supported on the support member, and wherein the support member has a plurality of through holes (46) that extend therethrough, the method comprising a step of molding (FIG. 15) in which the pad member and the support member are molded together as one piece, and wherein, in the step of molding, parts of the pad member are received in the corresponding through holes formed in the support member.

In this configuration, the plurality of through holes are formed in the support member and the pad member has the plurality of protrusions formed thereon, which receives the corresponding through holes in the support member. Furthermore, the contact surface of the pad member and the support surface of the support member are joined to each other. These features prevent the pad member from being shifted and/or offset with respect to the support member.

### BRIEF DESCRIPTION OF THE DRAWINGS

FIG. 1 is a perspective view of a vehicle seat in which the present invention is embodied;

FIG. 2 is a perspective view of a seat frame and a support member according to a first embodiment of the present invention;

FIG. 3 is a perspective view showing a pad member;

FIG. 4 is a cross-sectional view showing the pad member (a cross section taken along line IV-IV in FIG. 3);

FIG. 5 is a perspective view of a seat cushion of the first embodiment;

FIG. 6 is a cross-sectional side view of the seat cushion of the first embodiment;

FIG. 7 is a perspective view of a support member according to a second embodiment of the present invention;

FIG. 8 is a cross-sectional side view of a seat cushion of the second embodiment;

FIG. 9 is a perspective view of a support member according to a third embodiment of the present invention;

FIG. 10 is a cross-sectional side view of a seat cushion of the third embodiment;

FIG. 11 is a perspective view of a seat frame and a support member according to a fourth embodiment of the present invention;

FIG. 12 is a cross-sectional side view of a seat cushion of the vehicle seat of the fourth embodiment;

FIG. 13 is a perspective view of a support member according to a fifth embodiment of the present invention;

FIG. 14 is a cross-sectional side view of a seat cushion of the fifth embodiment;

FIG. 15 is an explanatory diagram showing a method for manufacturing a vehicle seat of the fifth embodiment;

FIG. 16 is a perspective view of a support member according to a seventh embodiment of the present invention;

FIG. 17 is an explanatory diagram showing a method for manufacturing the vehicle seat of the fifth embodiment;

FIG. 18 is a perspective view of a vehicle seat according to an eighth embodiment of the present invention;

FIG. 19 is a perspective view of a seat frame of the vehicle seat;

FIG. 20 is a cross-sectional view of a seat back including (a) and (b), where (a) is a diagram showing bags in a deflated state, and (b) is a diagram showing the bags in an inflated state;

FIG. 21 is a cross-sectional view of a seat back according to a ninth embodiment of the present invention;

FIG. 22 is a cross-sectional view of a seat back according to a tenth embodiment of the present invention;

FIG. 23 is a cross-sectional view of a seat back according to an eleventh embodiment of the present invention;

FIG. 24 is a cross-sectional view of a seat back according to a twelfth embodiment of the present invention;

FIG. 25 FIG. 24 is a cross-sectional view of a seat back according to a variant of the twelfth embodiment;

FIG. 26 is a cross-sectional view of a seat back according to a thirteenth embodiment of the present invention;

FIG. 27 is a cross-sectional view of a seat back according to a fourteenth embodiment of the present invention;

FIG. 28 is a cross-sectional view of a seat back according to a fifteenth embodiment of the present invention;

FIG. 29 is a cross-sectional view of a seat back according to a sixteenth embodiment of the present invention;

FIG. 30 includes (a) and (b), where (a) is a cross-sectional view of a back seat according to a seventeenth embodiment of the present invention, and (b) is a cross-sectional view of a back seat according to a variant of the seventeenth embodiment;

FIG. 31 is a cross-sectional view of a seat back according to an eighteenth embodiment of the present invention;

FIG. 32 is a cross-sectional view of a seat back according to a nineteenth embodiment of the present invention;

FIG. 33 is a cross-sectional view of a seat cushion according to a twentieth embodiment of the present invention, showing that the seat cushion is attached to an inner panel of a vehicle door;

FIG. 34 shows a seat cushion according to a twenty-first embodiment of the present invention, and includes diagrams (a) and (b) both showing the seat cushion that serves as a seat mat;

FIG. 35 is a diagram showing a sofa provided with a seat cushion according to a twenty-second embodiment of the present invention;

FIG. 36 is a cross-sectional view of a seat back according to a twenty-third embodiment of the present invention; and

FIG. 37 includes diagrams (a) and (b) illustrating a positional relationship between a bag and a first cushion component in a seat cushion according to a twenty-fourth embodiment of the present invention.

### DESCRIPTION OF THE PREFERRED EMBODIMENT(S)

Embodiments in which the present invention is embodied in an automobile seat 1 installed in a vehicle such as automobile will be described with reference to the appended drawings. In the following description, the front/rear (longitudinal), left/right (transverse), and up/down (vertical) directions are defined relative to a vehicle.

### First Embodiment

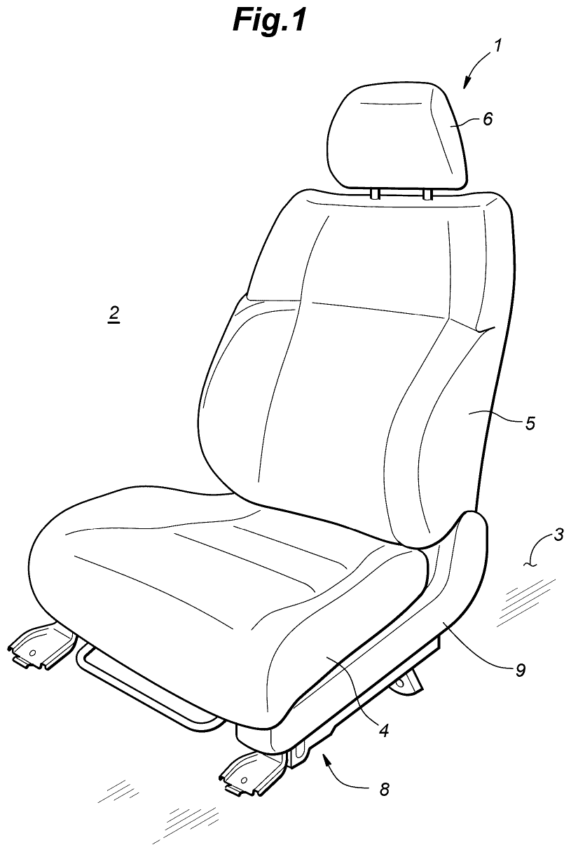

As shown in FIG. 1, the automobile seat 1 is provided on a floor 3 defining a bottom of a vehicle interior 2 such that the automobile seat 1 faces frontward. In the present embodiment, the automobile seat 1 is provided as a front seat.

The automobile seat 1 includes a seat cushion 4 coupled to the floor 3, a seat back 5 coupled to the rear of the seat cushion 4, and a headrest 6 provided on the top of the seat back 5. The seat cushion 4 supports the buttocks and thighs of an occupant. The seat back 5 supports the lower back and back of the occupant.

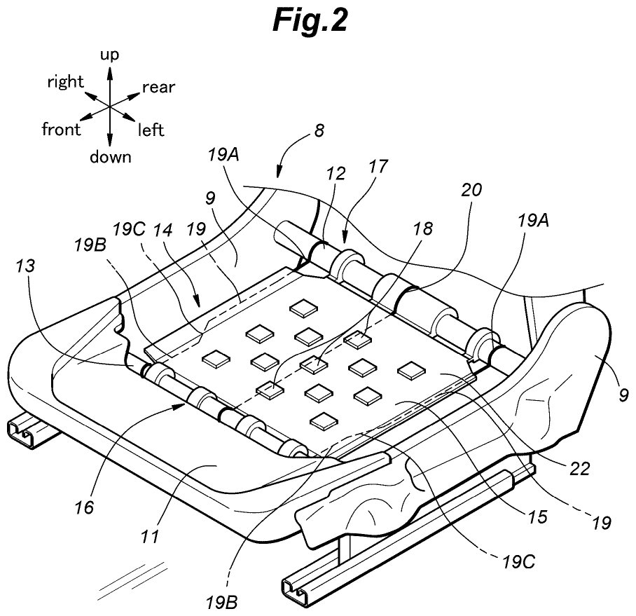

As shown in FIG. 2, the automobile seat 1 further includes a seat frame 8 that serves as a structural frame of the seat cushion 4. The seat frame 8 includes a pair of side members 9 on the left and right, and the left and right side members are provided at a distance from each other. Each of the left and right side members 9 is made of a metal plate-shaped member and extends in a front-rear direction. The left and right side members 9 are spaced apart from each other such that their main surfaces face each other.

The seat frame 8 includes a front member 11 that extends in a left-right direction and is connected to the front ends of the left and right side members 9. The front member 11 is made of a metal plate-shaped member having a width thereof in the front-rear direction. The front end of the front member 11 is located frontward of the front end of each of the left and right side members 9. In addition, the front member 11 has a front end part that protrudes upward.

The seat frame 8 further includes a rear member 12 that extends in the left-right direction and is connected to the rear ends of the left and right side members 9, and a middle member 13 that extends in the left-right direction and is connected to the left and right side members 9. The middle member 13 is provided between the front member 11 and the rear member 12 along the front-rear direction. The rear member 12 and the middle member 13 are made from metal tubular members and are provided with a gap therebetween in the front-rear direction.

The seat cushion 4 includes a support member 14 that is positioned between the middle member 13 and the rear member 12. The support member 14 includes a support member body 15, a plurality of first anchors 16 that extend frontward from the front end of the support member body 15 and curve in an arc to have a cap-shaped cross section (i.e., a reverse U-shaped cross section taken along line extending in the front-rear direction), and a plurality of second anchors 17 that extend rearward from the rear end of the support member body 15 and curve in an arc to have a cap-shaped cross section.

The support member body 15 is made of a flexible plastic material and generally has a plate-like shape. The support member body 15 has a plate-shaped portion having an up-facing surface and a down-facing surface. Moreover, the support member body 15 has left and right side inclined surfaces that extend outward and obliquely upward from the plate-shaped portion.

The plate-shaped portion of the support member body 15 has a plurality of support side protrusions that protrude upward from the up-facing surface. Each of the support side protrusions 18 of the support member body 15 has a rectangular shape with two pairs of side faces facing in the front-rear and left-right directions. In other cases, each of the support side protrusions 18 of the support member body 15 may have a conical shape.

The plurality of first anchors 16 and the plurality of second anchors 17 may be made of the same plastic material as the main body of the support member body 15. The first anchors 16 and the second anchors 17 each have an arcuate cross-sectional shape.

The support member 14 is attached to the seat frame 8, with the first anchors 16 and the second anchors 17 that are anchored to the middle member 13 and the rear member 12, respectively.

The support member 14 also has a plurality of side wires 19 and a center wire 20, each wire being made of metal, which extend in the front-rear direction and connect the middle member 13 and rear member 12. The side wires 19 on the left and right extend below the left and right side parts of the support member 14. The center wire 20 extends below a center part of the support member 14.

Each of the left and right side wires 19 has a first end portion 19A and a second end portion 19B extending in the front-rear direction, and connected to the rear member 12 and middle member 13, respectively, where the second end portion 19B is located transversely inward of the first end portion 19A. The front end of the first end portion 19A is positioned rearward of the rear end of the second end portion 19B. Furthermore, each of the two side wires 19 has a bend portion 19C connecting the front end of the first end portion 19A and the rear end of the second end portion 19B. Each of the first end portions 19A is provided so as to contact the lower surface of the corresponding side of the support member body 15, and extends from the rear member 12 to a center of the support member 14 in the front-rear direction. Each second end portion 19B is provided to contact the lower surface of the corresponding side of the plate-shaped portion of the support member body 15, and extends from the center of the support member 14 to the middle member 13. Each second end 19B is provided to contact the lower surface of the corresponding side of the plate-shaped portion of the support member body 15, and extends from the center of the support member 14 to the middle member 13.

The front and rear end portions of the center wire 20 curve in arc as viewed from a side. The front and rear end portions of the center wire 20 are hooked onto the corresponding second anchor 17 and first anchor 16, respectively.

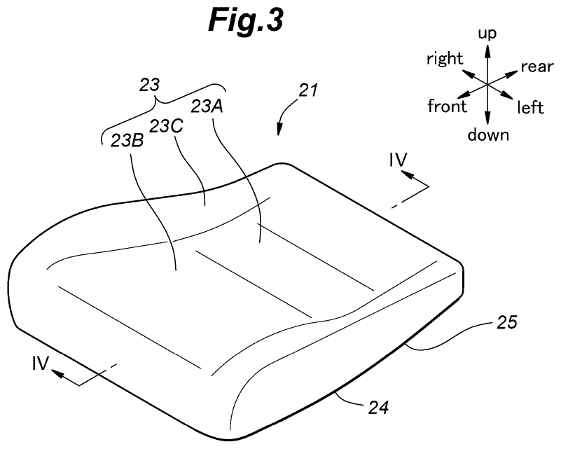

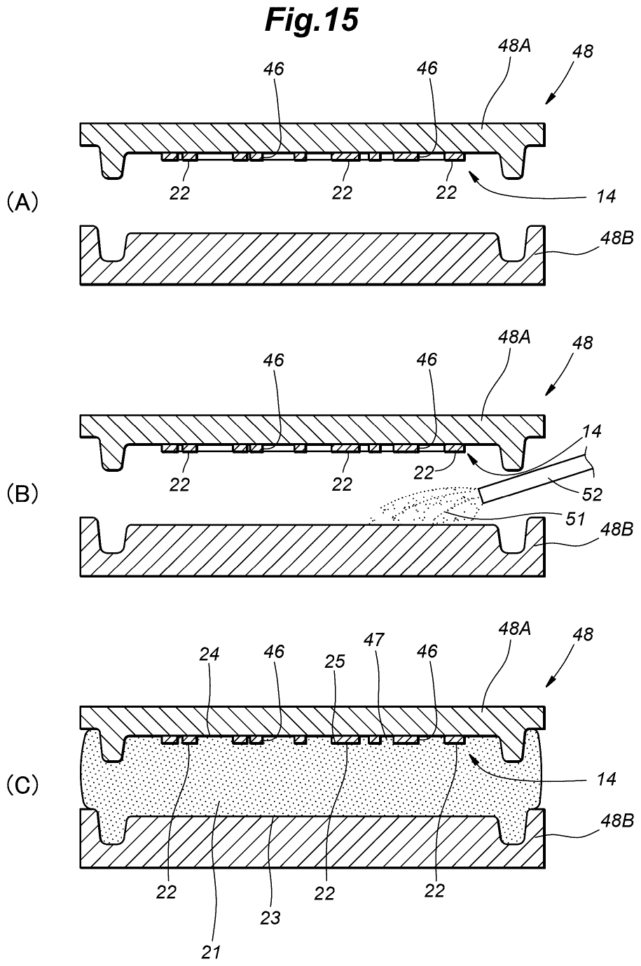

As shown in FIG. 3, the seat cushion 4 has a pad member 21 supported by the support member 14. The pad member 21 is a component having a three-dimensional shape formed by injection foam molding or extrusion foam molding of a plastics foam material such as polyurethane foam (FIG. 15). This feature allows the pad member 21 to be elastic. The pad member 21 is provided to cover the front member 11, rear member 12 and support member 14 of the seat frame 8 from the above.

The pad member 21 has an upper surface 23 that supports the buttocks and thighs of an occupant. The upper surface 23 includes a first upper surface 23A that forms the rear center of the upper surface 23, a second upper surface 23B that extends frontward from the first upper surface 23A and forms the front center of the upper surface 23, and two third upper surfaces 23C each extending transversely outward from the center of the upper surface 23 of the pad member 21.

The first upper surface 23A has an up-facing surface. The second upper surface 23B has an inclined surface that extends rearward and obliquely upward. Each of the third upper surfaces 23C has an inclined surface that extends transversely outward and obliquely upward.

The pad member 21 has a lower surface 24 that comes into contact with the front member 11, rear member 12 and support member 14 in the seat frame 8. In other words, part of the lower surface 24 of the pad member 21 comes into contact with the top surface of the support member body 15, which causes the pad member 21 to be supported on the support member 14. Both the up-facing surface of the plate-shaped portion of the support member body 15 and the top surfaces of the inclined portions serve as a support surface 22 for supporting the pad member 21. The lower surface 24 of the pad member 21, which comes into contact with the support surface 22 of the support member body 15, forms a contact surface 25.

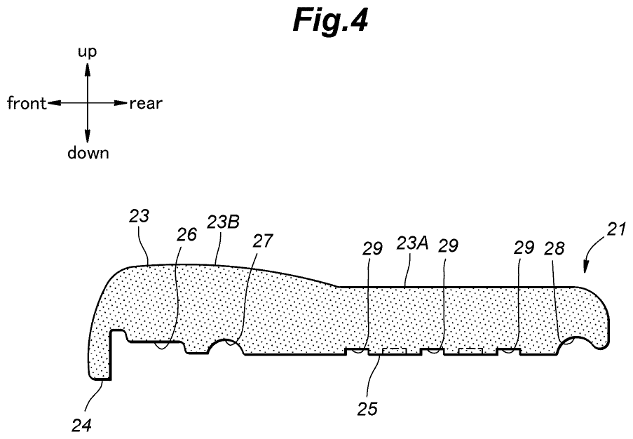

As shown in FIG. 4, the lower surface 24 of the pad member 21 has a plurality of receiving grooves that extend in the left-right direction and are recessed upward. In the present embodiment, three receiving grooves are formed on the lower surface 24. The three receiving grooves include a first receiving groove 26, a second receiving groove 27, and a third receiving groove 28, in order from front to rear. The first receiving groove 26 extends along, i.e. overlaps the front end of the second upper surface 23B of the pad member 21, as viewed from above. The second receiving groove 27 extends along, i.e. overlaps the rear end of the second upper surface 23B of the pad member 21, as viewed from above. The third receiving groove 28 extends along, i.e. overlaps the rear end of the first upper surface 23A of the pad member 21, as viewed from above.

The contact surface 25 of the pad member 21 has a plurality of pad side recesses 29 that recesses upward. Each of the pad side recesses 29 has a rectangular shape in plan view, and is formed within, i.e., overlaps the first upper surface 23A of the pad member 21 as viewed from above.

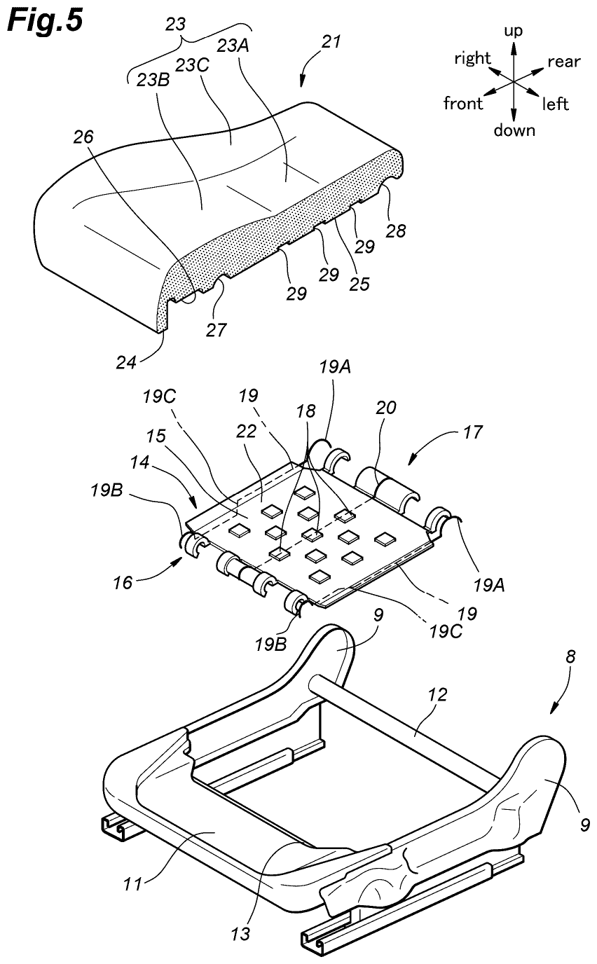

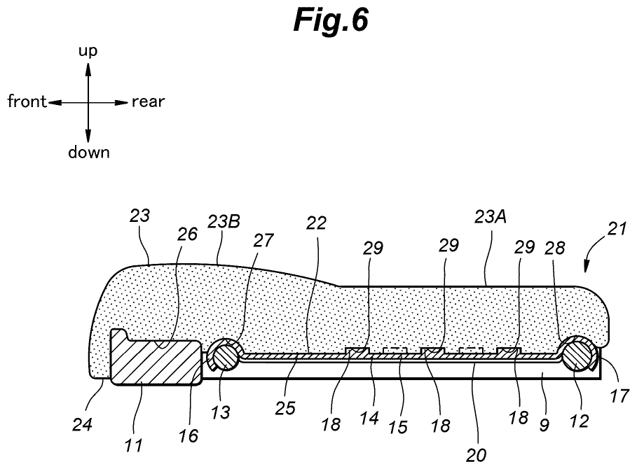

As shown in FIGS. 5 and 6, when the pad member 21 is placed on the seat frame 8 and the support member 14, the first receiving groove 26 receives the front end of the front member 11. The second receiving groove 27 receives the middle member 13 via the first anchors 16 of the support member 14. The third receiving groove 28 receives the rear member 12 via the second anchors 17 of the support member 14. Each of the pad side recesses 29 receives the corresponding support side protrusions 18 formed on the support member body 15.

The pad member 21 placed on the seat frame 8 and the support member 14, is covered with an outer skin (not shown) and is made of a stretchable fabric, or any other suitable material. The outer skin forms the appearance of the automobile seat 1.

When an occupant is seated in the automobile seat 1, the occupant's buttocks are supported by the first upper surface 23A of the pad member 21, and the occupant's thighs are supported by the second upper surface 23B of the pad member 21. The first upper surface 23A of the pad member 21 overlaps a big part of the support surface 22 of the support member 14, as viewed from above. When the occupant is seated in the automobile seat 1 and a load caused by the occupant's weight is applied to the pad member, the upper surface 23 of the pad member 21 is deformed such that the pad member is recessed downward. The support member 14 supports the pad member 21 while bending downward due to a load caused by the occupant's weight applied thereto. This allows the automobile seat 1 to be comfortable for the seated occupant.

The load acting on the support member 14 is transmitted to the rear member 12 and middle member 13 via the left and right side wires 19 and center wire 20. This improves the durability of the support member 14.

When the occupant is seated, loads caused by the occupant's weight are applied to the pad member 21 in oblique directions that extend vertically and horizontally (in the front-rear and left-right directions). The horizontal components of the applied loads exert forces that can cause the pad member 21 to move. When the pad member 21 is placed on the support member 14, the pad side recesses 29 in the pad member 21 receive the corresponding support side protrusions 18 formed on the support member 14. This causes the protrusions to be caught in the pad member 21, which prevents the pad member 21 from being shifted and/or offset with respect to the support member 14. In addition, the protrusions clawing into the pad member 21 also prevent the outer skin (not shown) from being shifted and/or offset with respect to the support member 14. This reduces the formation of wrinkles in the outer skin, thereby maintaining the good appearance of the automobile seat 1.

Each of the support side protrusions 18 on the support member 14 has a rectangular shape with two pairs of side faces facing in the front-rear and left-right directions, which prevents the pad member 21 from being shifted and/or offset with respect to the support member 14 in the front-rear and left-right directions. As a result, the pad member 21 is more effectively prevented from being shifted and/or offset with respect to the support member 14.

In other embodiments, the lower surface 24 of the pad member 21 may have no pad side recesses 29 that can receive the support side protrusions 18 on the support surface 22 of the support member 14. Downward forces (such as loads caused by the pad member 21 or an occupant' weight) act on the pad member 21. As a result, the contact surface 25 of the pad member 21 is deformed to receive the protrusions formed on the support surface 22 of the support member 14. This deformation of the contact surface 25 of the pad member 21 has the same effect as the pad side recesses 29 in the above embodiment. Thus, this configuration can prevent the pad member 21 from being shifted and/or offset with respect to the support member 14.

### Second Embodiment

An automobile seat 1 of a second embodiment of the present invention is different from the first embodiment in that a support member 14 and a pad member 21 are configured differently. In the description of the second embodiment, the same features or elements as those of the first embodiment are denoted with same reference numerals without repeating the description thereof. In the drawings related to the second embodiment, the side wires 19 and the center wire 20 are not shown for clarity.

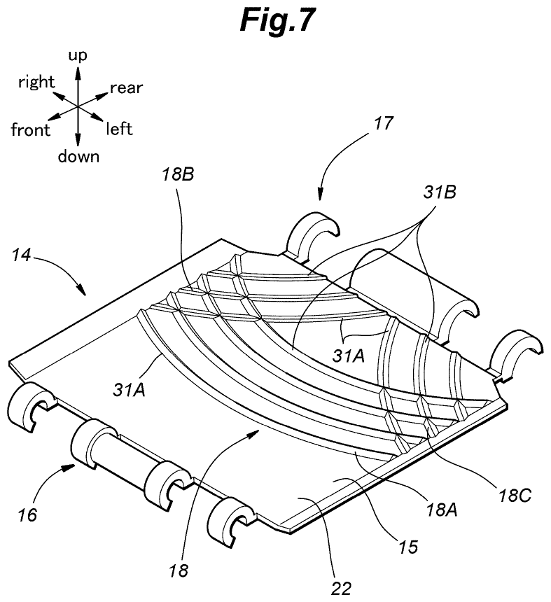

As shown in FIG. 7, the support side protrusions 18 on the support surface 22 of the support member body 15 include a plurality of first support side protrusions 18A, a plurality of second support side protrusions 18B, and a plurality of third support side protrusions 18C. The first, second, and third support side protrusions 18A, 18B, and 18C extend along the support surface 22 in three directions that are different from each other.

Each of the first, second, and third support side protrusions 18A, 18B, 18C comprises a curved elongated protrusion along the support surface 22. The first, second, and third support side protrusions 18A, 18B, 18C are unevenly provided to be distributed in a rear part of the support surface 22.

Each of the first support side protrusions 18A, which is a curved elongated protrusion, extends generally in the left-right direction and curves toward the front. The plurality of first support side protrusions 18A extend within a rear part of the support surface 22, with a gap between each other in the front-rear direction.

The plurality of second support side protrusions 18B extend within a rear right part of the support surface 22. Each of the second support side protrusions 18B, which is a curved elongated protrusion, extends generally frontward toward the right from the rear and curves inward. The plurality of second support side protrusions 18B extend on the support surface 22, with a gap between each other along a line extending frontward toward the right from the rear.

The plurality of third support side protrusions 18C extend within a rear left part of the support surface 22. Each of the third support side protrusions 18C, which is a curved elongated protrusion, extends generally frontward toward the left from the rear and curves inward. The plurality of third support side protrusions 18C extend on the support surface 22, with a gap between each other along a line extending frontward toward the left from the rear.

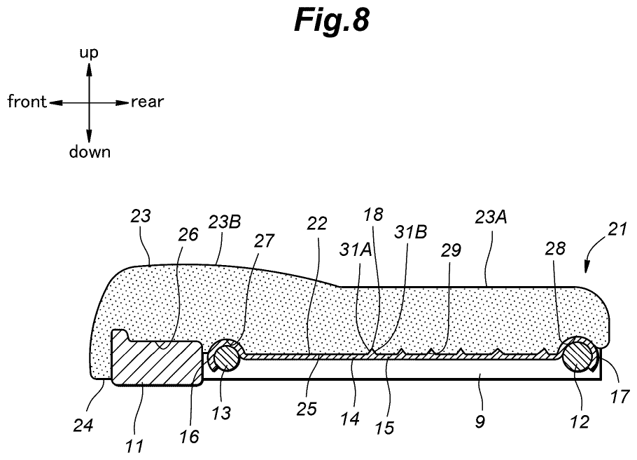

Each of the support side protrusions 18A, 18B, and 18C has a tapered cross-sectional shape that tapers upward (FIG. 8). In other words, each of the support side protrusions 18A, 18B, and 18C has a first inclined surface 31A facing upward and frontward, and a second inclined surface 31B facing upward and rearward. In other cases, each of the support side protrusions 18A, 18B, and 18C may have a triangular cross-sectional shape.

As shown in FIG. 8, the contact surface 25 of the pad member 21 has the pad side recesses 29 formed thereon, which receive the support side protrusions 18A, 18B, and 18C on the support surface 22 of the support member body 15.

When the pad member 21 is placed on the support member 14, the pad side recesses 29 in the pad member 21 receive the corresponding support side protrusions 18 formed on the support member body 15. This causes the support side protrusions 18 to be caught in the pad member 21, which prevents the pad member 21 from being shifted and/or offset with respect to the support member 14.

The configuration in which each of the support side protrusions 18A, 18B, 18C has a tapered cross-sectional view that tapered upward, facilitates the assembly work to have the support side protrusions 18A, 18B, 18C received in the corresponding recesses 29 of the pad member 21.

When the occupant is seated, loads caused by the occupant's weight are applied to the pad member 21 in oblique directions that extend vertically and horizontally (in the front-rear and left-right directions). Each of the support side protrusions 18A, 18B, 18C has the first inclined surface 31A facing upward and frontward, which can provide a right-angle support against loads caused by the occupant's weight and applied in oblique directions that extend downward and rearward, the directions being generally perpendicular to the first inclined surface 31A. Each of the support side protrusions 18A, 18B, 18C has the second inclined surface 31B facing upward and rearward, which can provide a right-angle support against loads caused by the occupant's weight and applied in oblique directions that extend downward and frontward, the directions being generally perpendicular to the first inclined surface 31B. This feature causes the support side protrusions 18 to be effectively caught in the pad member 21, which prevents the pad member 21 from being shifted and/or offset with respect to the support member 14.

The first support side protrusion 18A, second support side protrusion 18B and third support side protrusion 18C extend in directions that are different from each other. In addition, the first support side protrusion 18A, second support side protrusion 18B and third support side protrusion 18C curve toward directions that are different from each other. This feature allows at least one of the first support side protrusion 18A, second support side protrusion 18B and third support side protrusion 18C to provide a right-angle support against loads caused by the occupant's weight, which effectively prevents the pad member 21 from being shifted and/or offset with respect to the support member 14.

A rear part of the support surface 22 overlaps the buttocks of an occupant as viewed from above. Thus, loads caused by the occupant's weight tend to concentrate over the rear part of the support surface 22. The first, second, and third support side protrusions 18A, 18B, 18C are unevenly provided to be distributed in the rear part of the support surface 22 of the support member 14. This feature causes the support side protrusions 18 to be effectively caught in the pad member 21, which prevents the pad member 21 from being shifted and/or offset with respect to the support member 14.

### Third Embodiment

An automobile seat 1 of a third embodiment of the present invention is different from the first embodiment in that a support member 14 and a pad member 21 are configured differently. In the description of the third embodiment, the same features or elements as those of the first embodiment are denoted with same reference numerals without repeating the description thereof.

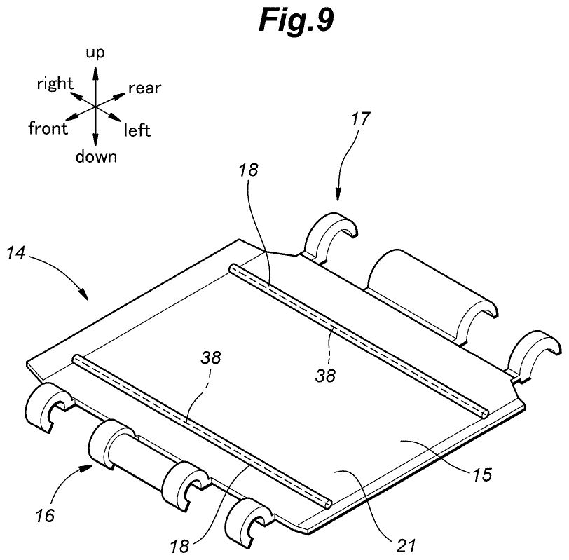

As shown in FIG. 9, each of the plurality of support side protrusions 18 on the support surface 22 of the support member body 15 extends in the left-right direction. In the present embodiment, the two support side protrusions 18 are away from each other with a distance therebetween in the front-rear direction. The two support side protrusions 18 are at the front end and rear end of the support member body 15. Each of the two support side protrusions 18 has a first wire 38 embedded therein. The first wires 38 are preferably made of the same metal as the side wires 19 and center wire 20.

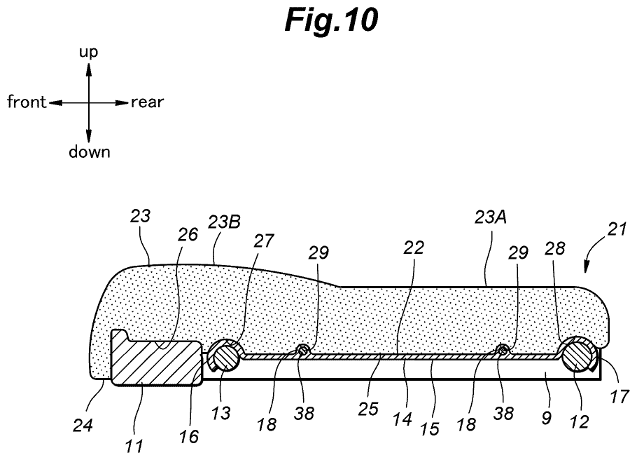

As shown in FIG. 10, the pad side recesses 29 on the contact surface 25 of the pad member 21 are recessed upward from the contact surface 25 and extend in the left-right direction. In the present embodiment, the two pad side recesses 29 transversely extend with a distance therebetween. The two pad side recesses 29 extend to overlap the corresponding support side protrusions 18 on the support surface 22 of the support member body 15, as viewed from above. When the pad member 21 is placed on the seat frame 8 and the support member 14, each of the two pad side recesses 29 receives the corresponding one of the support side protrusions 18.

When the pad member 21 is placed on the support member 14, each of the two pad side recesses 29 on the contact surface 25 of the pad member 21 receives the corresponding support side protrusions 18 on the support surface 22 of the support member body 15. This causes the support side protrusions 18 to engage the pad member 21, which prevents the pad member 21 from being shifted and/or offset with respect to the support member 14. Each of the two support side protrusions 18 has a corresponding one of the first wires 38 embedded therein, which improves the durability of each support side protrusion 18.

### Fourth Embodiment

An automobile seat 1 of a fourth embodiment of the present invention is different from the third embodiment in that a seat frame 8 and a pad member 21 are configured differently. In the description of the fourth embodiment, the same features or elements as those of the third embodiment are denoted with same reference numerals without repeating the description thereof.

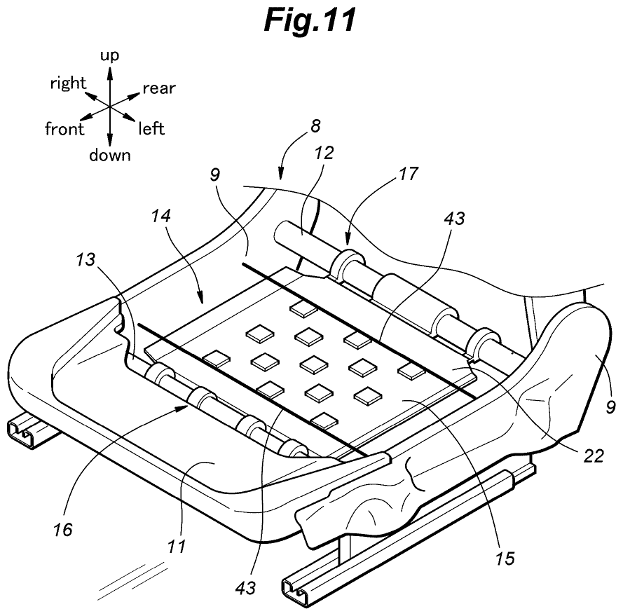

As shown in FIG. 11, the seat frame 8 includes a plurality of second wires 43 that extend in the left-right direction and are connected to the left and right side members 9. In the present embodiment, the second wires 43 are located above the front and rear end parts of the support member 14. Each of the two second wires 43 may be made of the same material as the first wire 38 and the two side wires 19.

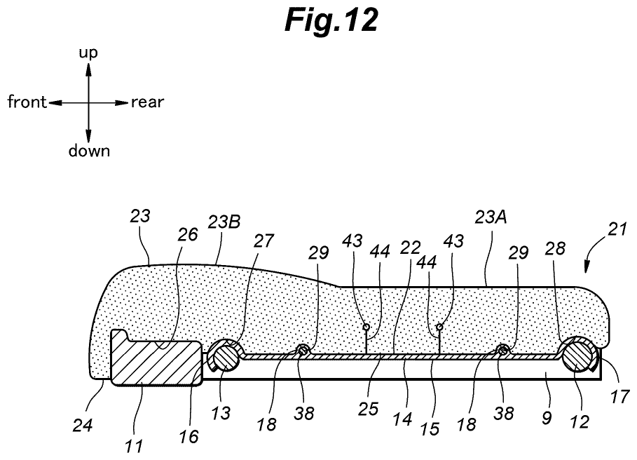

As shown in FIG. 12, the contact surface 25 of the pad member 21 has incisions 44 each receiving a corresponding one of the plurality of second wires 43. The incisions 44 may be formed by a process which includes the step of cutting into the contact surface 25 of the pad member 21 to a predetermined depth using a tool such as a cutter. When each of the second wires 43 is not received in a corresponding one of the incision 44, front and rear facing surfaces that define each incision may be in contact with each other.

The pad member 21 is elastic. Thus, when each of the plurality of second wires 43 is received in a corresponding one of the incisions 44 defined by the front and rear facing surfaces, a force is applied to one of the front and rear facing surfaces that is in contact with each of the second wires 43. As a result, the second wires 43 are engaged in the pad member 21.

The two second wires 43 are supported by the pad member 21, which prevents the pad member 21 from moving in the front-rear direction. In other words, this configuration prevents the pad member 21 from being shifted and/or offset with respect to the support member 14. In addition, each of the two second wires 43 is connected to the left and right side members 9, which means that, even when the automobile seat has such a simple structure that does not include a front member 11 or rear member 12, the pad member 21 is prevented from being shifted and/or offset with respect to the support member.

### Fifth Embodiment

An automobile seat 1 of a fifth embodiment of the present invention is different from the first embodiment in that a support member 14 and a pad member 21 are configured differently. In the description of the fifth embodiment, the same features or elements as those of the first embodiment are denoted with same reference numerals without repeating the description thereof.

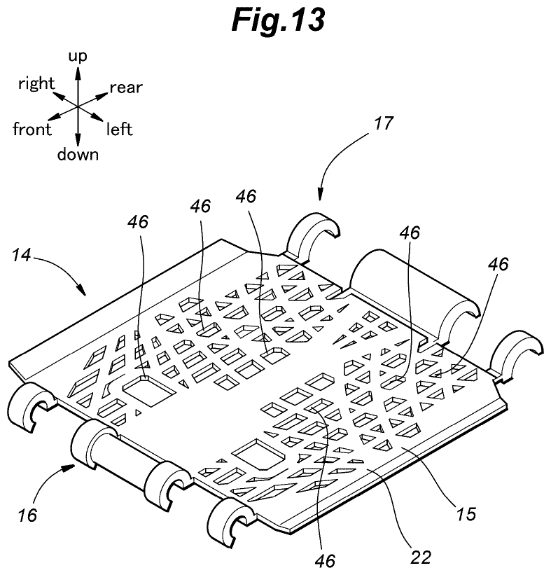

As shown in FIG. 13, the support member 14 has a plurality of through holes 46 that extending therethrough in the vertical direction. Examples of the shape of each through hole 46 as viewed from above may include, but not limited to, a polygonal shape such as a triangle, square, or pentagon. Alternatively, the plurality of through holes 46 may include those of different shapes. In some cases, the plurality of through holes 46 may be positioned in a regular pattern. Alternatively, the plurality of through holes 46 may be positioned in an irregular pattern.

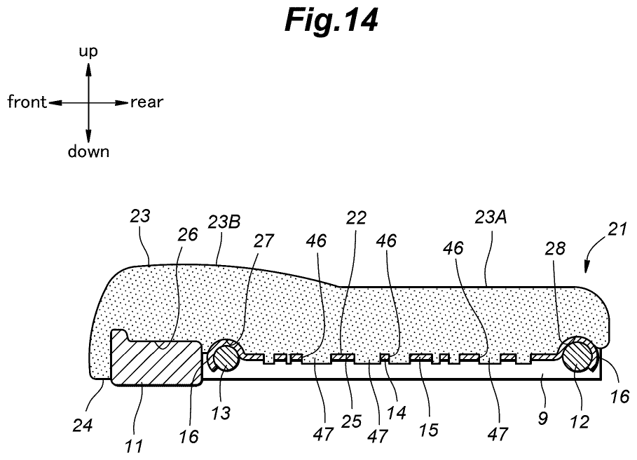

As shown in FIG. 14, the contact surface 25 of the pad member 21 has a plurality of pad side protrusions 47 that protrude toward the support surface 22 of the support member 14. The plurality of pad side protrusions 47 are preferably formed in the process of molding the pad member 21. Although the plurality of pad side protrusions 47 may be provided in an irregular pattern or form, at least some of the pad side protrusions 47 are preferably received in corresponding ones of the through holes 46 of the support member 14.

When the pad member 21 is placed on the support member 14, at least some of the through holes 46 of the support member 14 receive corresponding pad side protrusions 47 formed on the pad member 21. As a result, the received pad side protrusions 47 are caught in the pad member 21, which prevents the pad member 21 from being shifted and/or offset with respect to the support member 14.

In other embodiments, the pad member 21 may not have a plurality of pad side protrusions 47. In this case, when a downward force, such as a load caused by the weight of the pad member 21 and an occupant's weight is applied to the pad member, acts on the pad member 21, the upper surface 23 of the pad member 21 is deformed such that parts of the pad member extend through the through holes 46. This deformation of the contact surface 25 of the pad member 21 has the same effect as the pad side protrusions 47 in the above embodiment. Thus, this configuration can prevent the pad member 21 from being shifted and/or offset with respect to the support member 14.

### Sixth Embodiment

An automobile seat 1 of a sixth embodiment of the present invention is different from the fifth embodiment in that a support member 14 is integrally formed with a pad member 21. In the description of the sixth embodiment, the same features or elements as those of the fifth embodiment are denoted with same reference numerals without repeating the description thereof.

The pad member 21 is a component formed by injection foam molding or extrusion foam molding of a plastics foam material such as polyurethane foam. Specifically, as shown in FIG. 15, a manufacturing device 48 for manufacturing the pad member 21 has a first mold 48A and a second mold 48B that are arranged to face each other with a vertical gap therebetween. The first mold 48A is positioned on the upper side, while the second mold 48B is positioned on the lower side.

The lower surface of the first mold 48A and the upper surface of the second mold 48B have respective complex-shaped curved surfaces. The lower surface of the first mold 48A and the upper surface of the second mold 48B have the curved surfaces, which are used to form the lower surface 24 and the upper surface 23 of the pad member 21, respectively. In other words, the lower surface of the first mold 48A and the upper surface of the second mold 48B form surfaces of the vertically flipped pad member 21, i.e., the upper surface and the lower surface of the pad member 21, respectively.

As shown in FIG. 15(A), a method of manufacturing the automobile seat 1 includes the first step of attaching the support member 14 to the first mold 48A. Specifically, the support member 14 is attached to the first mold 48A such that the lower surface of the support member 14 when in use, which is the opposite surface to the support surface 22, is in contact with the lower surface of the first mold 48A. The support member 14 has the plurality of through holes 46 extending therethrough. The lower surface of the first mold 48A has parts which overlap the through holes 46 of the support member 14 as viewed from below, and those parts of the lower surface are made smooth.

As shown in FIG. 15(B), the method of manufacturing includes, after the step of attaching the support member 14 to the first mold 48A, filling the plastics foam material 51 between the first mold 48A and the second mold 48B. The step of filing the plastics foam material 51 is preferably performed by using a nozzle 52, for example.

As shown in FIG. 15(C), the method of manufacturing further includes molding the plastics foam material 51 by using a foam molding process to form the pad member 21. In this molding step, the pad member 21 and the support member 14 are molded together as a single piece. In the molding step, part of the plastics foam material 51 is filled into each of the plurality of through holes 46 of the support member 14. As a result, portions of the pad member 21 are received in the plurality of through holes 46 of the support member 14. The parts of the pad member 21 received in the plurality of through holes 46 of the support member 14 form the pad side protrusions 47. Thus, the plurality of pad side protrusions 47 on the support surface 22 of the pad member 21 are integrally formed with the corresponding through holes 46 of the support surface 22 of the support member 14.

In other embodiments, the support surface 22 of the support member 14 may have a plurality of support side recesses that are recessed downward. In this case, the molding step involves filling part of the plastics foam material 51 into each of the support side recesses of the support member 14. As a result, each of the pad side protrusions 47 on the support surface 22 of the pad member 21 is integrally formed with a corresponding one of the support side recesses formed in the support surface 22 of the support member 14.

The pad member 21 and the support member 14 are molded as a single piece, which causes the pad side protrusions 47 to be received in the corresponding through holes 46 of the support surface 22 of the support member 14, while causing the contact surface 25 of the pad material to be joined to the support surface 22 of the support member 14. In addition, the pad side protrusions 47 on the support surface 22 of the pad member 21 are integrally formed with the corresponding through holes 46 on the support surface 22 of the support member 14. Furthermore, the pad side protrusions 47 are caught in the corresponding through holes 46 of the support member 14. These features prevent the pad member 21 from being shifted and/or offset with respect to the support member 14.

### Seventh Embodiment

An automobile seat 1 of a seventh embodiment of the present invention is different from the fifth embodiment in that a support member 14 and a pad member 21 are configured differently. In the description of the seventh embodiment, the same features or elements as those of the fifth embodiment are denoted with same reference numerals without repeating the description thereof.

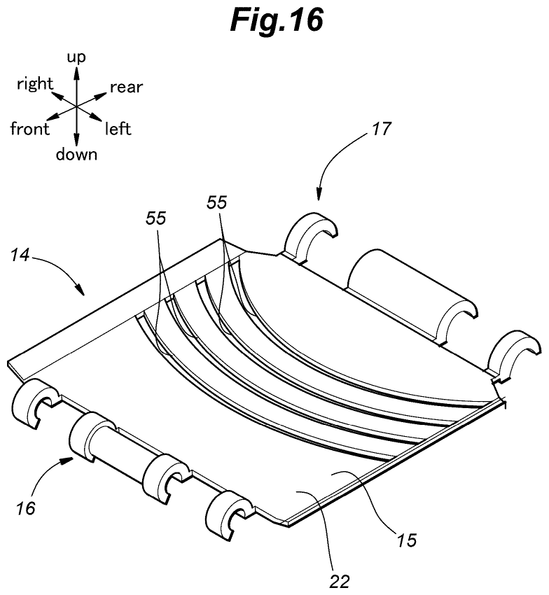

As shown in FIG. 16, the support member 14 has a plurality of slits 55 in the rear part that vertically extend therethrough from the support surface 22 and horizontally extend generally in the left-right direction. The slits 55 each curve toward the front, and are arranged with a gap between adjoining ones of the slits 55.

Although no details are shown, the pad side protrusions 47 on the contact surface 25 of the pad member 21 generally extend in the left-right direction and curve frontward so that the pad side protrusions 47 can be received in the corresponding slits 55.

When the pad member 21 is placed on the support member 14, the pad side protrusions 47 on the contact surface 25 of the pad member 21 are received in the corresponding slits 55. As a result, the pad side protrusions 47 are caught in the corresponding slits 55 of the support member 14. This prevents the pad member 21 from being shifted and/or offset with respect to the support member 14.

A rear part of the support surface 22 overlaps the buttocks of an occupant as viewed from above. Thus, loads caused by the occupant's weight tend to concentrate over the rear part of the support surface 22. The slits 55 are unevenly provided to be distributed in the rear part of the support surface 22 of the support member 14, which effectively enables the pad side protrusions 47 to be effectively caught in the support member 14. This means that the pad member 21 is prevented from being shifted and/or offset with respect to the support member 14.

### Eighth Embodiment

A manufacturing device 48 for manufacturing an automobile seat 1 of an eighth embodiment of the present invention is different from the manufacturing device 48 of the sixth embodiment in that a first mold 48A is configured differently. In the description of the eighth embodiment, the same features or elements of the automobile seat 1 and the manufacturing device 48 for manufacturing the automobile seat 1 as those of the sixth embodiment are denoted with same reference numerals without repeating the description thereof.

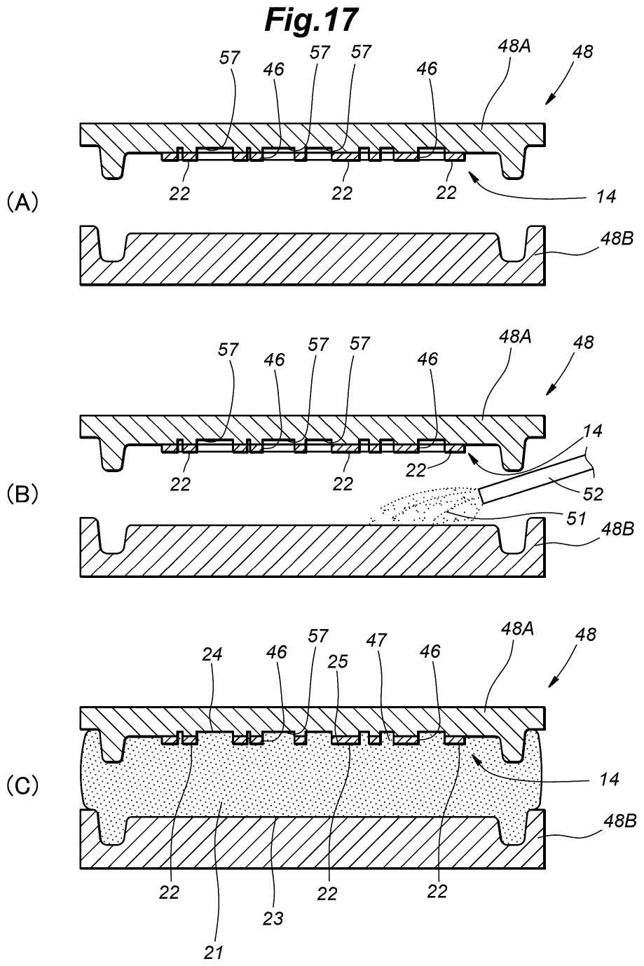

As shown in FIG. 17, the lower surface of a first mold has a plurality of grooves 57 that are recessed upward. When the support member 14 is attached to the first mold 48A, each of the grooves 57 is aligned with a corresponding one of the through holes 46 extending from the support surface 22 of the support member 14.

As shown in FIG. 17(A), a method of manufacturing the automobile seat 1 includes the first step of attaching the support member 14 to the first mold 48A. Specifically, the support member 14 is attached to the first mold 48A such that the lower surface of the support member 14 in use is in contact with the lower surface of the first mold 48A.

As shown in FIG. 17(B), the method of manufacturing includes, after the step of attaching the support member 14 to the first mold 48A, filling the plastics foam material 51 between the first mold 48A and the second mold 48B. The step of filing the plastics foam material 51 is preferably performed by using a nozzle 52, for example.

As shown in FIG. 17(C), the method involves the molding step in which the pad member 21 and the support member 14 are molded together as a single piece. In the molding step, part of the plastics foam material 51 is filled into each of the plurality of through holes 46 of the support member 14 and each of the plurality of grooves 57 of the first mold 48A. As a result, portions of the pad member 21 are received in the plurality of through holes 46 of the support member 14 and the plurality of grooves 57 of the first mold 48A. The parts of the pad member 21 received in the plurality of through holes 46 of the support member 14 and the plurality of grooves 57 of the first mold 48A form the pad side protrusions 47. Thus, the plurality of pad side protrusions 47 on the support surface 22 of the pad member 21 are integrally formed with the corresponding through holes 46 of the support surface 22 of the support member 14. When the pad member 21 and the support member 14 are removed from the manufacturing device 48, the pad side protrusions 47 on the support surface 22 of the pad member 21 extends through the corresponding through holes 46 extending from the support surface 22 of the support member 14.

The pad member 21 and the support member 14 are molded as a single piece, which causes the pad side protrusions 47 to be received in the corresponding through holes 46 of the support surface 22 of the support member 14, while causing the contact surface 25 of the pad member 21 to be joined to the support surface 22 of the support member 14. In addition, the pad side protrusions 47 on the support surface 22 of the pad member 21 are integrally formed with the corresponding through holes 46 on the support surface 22 of the support member 14. Furthermore, the pad side protrusions 47 are caught in the corresponding through holes 46 of the support member 14. These features prevent the pad member 21 from being shifted and/or offset with respect to the support member 14.

Specific embodiments of the present invention are described above. However, those embodiments are non-limiting, and various modifications may be made to the embodiments without departing from the scope of the present invention. For example, although the pad member 21 and the support member 14 are provided in the seat cushion 4 in the sixth and eighth embodiments, a pad member 21 and a support member 14 may be provided in the seat back 5. Although, in the sixth and eighth embodiments, the pad member 21 and the support member 14 with the through holes 46 formed therein are integrally formed, the pad member 21 and the support member 14 with a plurality of protrusions 18 formed thereon may be integrally formed as a single piece.

### Eighth Embodiment

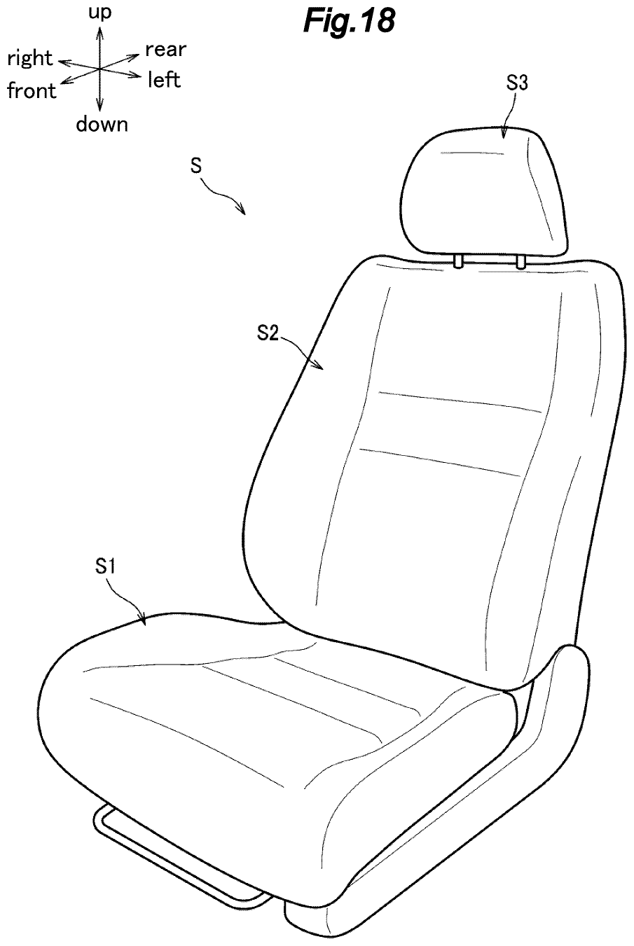

Next, details of a vehicle seat according to an eighth embodiment of the present invention, with reference to the appended drawings. As shown in FIG. 18, a vehicle seat S is a seat installed in, for example, an automobile, for example. The vehicle seat may also be a seat installed in a ship or an aircraft. In the following description, the front/rear (longitudinal), left/right (transverse), and up/down (vertical) directions are defined relative to a user seated in a vehicle seat S.

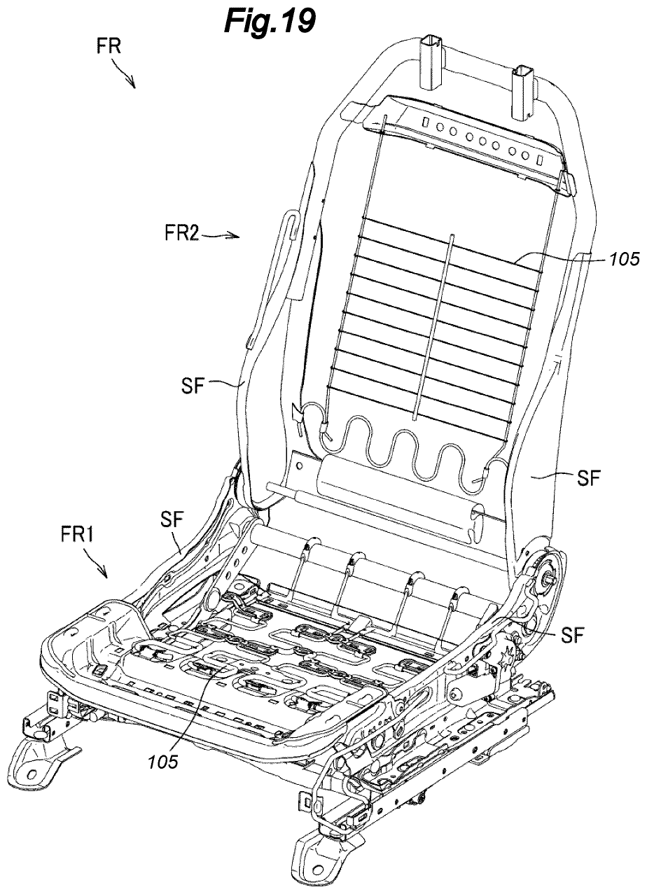

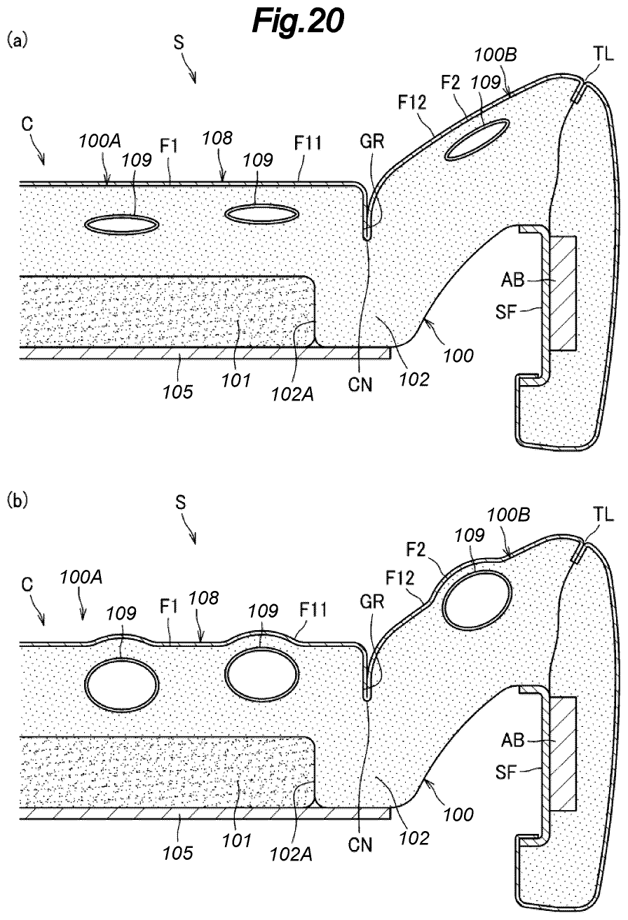

The vehicle seat S includes a seat bottom S1, a seat back S2, and a headrest S3. More specifically, the vehicle seat S includes a seat frame FR as shown in FIG. 19, and seat cushions C as shown in FIG. 20. The seat cushions C are supported by the seat frame FR.

As shown in FIG. 19, the seat frame FR has a seat bottom frame FR1 that serves as a frame of the seat bottom S1 and a seat back frame FR2 that serves as a frame of the seat back S2. The seat cushions C are attached to the seat back frame FR2 and the seat bottom frame FR1, respectively.

Although not shown, a frame of a headrest S3 is removably attached to the upper end of the seat back frame FR2. The frame of the headrest S3 is covered with a pad body and a skin cover. In other words, the seat cushion is also attached to the frame of the headrest S3.

The seat bottom frame FR1 and the seat back frame FR2 have respective pairs of left and right side frames SF that are provided at a distance from each other in the left-right direction, and respective support members 105 that are provided between the corresponding pairs of left and right side frames SF and receive loads caused by a user's weight. As shown in FIG. 20, the support members 105 support center parts of the corresponding seat cushions C.

The seat cushion C shown in FIG. 20 is a seat cushion that forms the seat back S2. The seat cushion C also has a seat bottom structure forming the seat bottom S1, is generally the same as that of the seat cushion C that forms the seat back S2, and the description thereof is not repeated.

The seat cushion C includes a pad body 100 that covers the seat frame FR, a skin cover 108 that covers a pad body 100, bags 109 as examples of movable components, and an airbag device AB. The skin cover 108 is made of any suitable material such as synthetic leather or fabric material.

As shown in FIG. 20, the pad body 100 has a base component 100A, and bulge components 100B located on the left and right of the base component 100A. The bulge components 100B bulge out toward a seated user more than the base component 100A. As the pad body 100 is generally symmetrical, FIG. 20 shows an enlarged view of part of the pad body 100 on one of the left and right.

The base component 100A has a first support surface F1 that faces a user. The bulge component 100B, which is one of the left and right bulge components, has a second support surface F2 that faces the user. The first support surface F1 and the second support surface F2 come into contact with the skin cover 108, and are configured to support a user via the skin cover 108.

The pad body 100 has a draw-in groove GR for drawing the skin cover 108 therein. The first support surface F1 is connected to the second support surface F2 at a bottom of the draw-in groove GR. In other words, a connection part CN where the first support surface F1 is connected to the second support surface F2, is located at the bottom of the draw-in groove GR on each side. The draw-in groove GR is formed at a position which is within a positional range of the support member 105 in the left-right direction.

The skin cover 108 has a first user side surface F11 extending along and over the first support surface F1 and a second user side surface F12 extending along and over the second support surface F2. The first user side surface F11 and the second user side surface F12 face the user seated on the vehicle seat S and can contact and support the user.

The pad body 100 includes a first cushion component 101 and a second cushion component 102, both being made of biomass urethane. Biomass urethane is a urethane foam that contains at least 35% and preferably 50% or more of raw materials derived from plants. For example, ECOLOCEL (Registered Trademark) can be used as biomass urethane.

The first cushion component 101 comprises a part of the base component 100A opposite to the user. The first cushion component 101 is positioned to avoid the first support surface F1 of the bulge component 100B. As used herein, the expression “the first cushion component 101 is positioned to avoid sth (e.g., the first support surface F1)” means that the first cushion component 101 is positioned such that the first cushion component 101 is away from sth. In other words, the expression means that the first cushion component 101 is positioned such that boundaries of the first cushion component 101 do not touch sth. Similarly, the expression “a position of the first cushion component 101 that avoids sth” means “a position of the first cushion component 101 that is away from sth” or “a position where boundaries of the first cushion component 101 do not touch sth.”

The first cushion component 101 is provided between the left and right bulge components 100B in the left-right direction. The first cushion component 101 is positioned to avoid the connection part CN (i.e., to be away from the connection part CN). The first cushion component 101 is provided between the left and right draw-in grooves GR in the left-right direction.

The first cushion component 101 is away from the airbag device AB. The first cushion component 101 is provided to be away from a tear line TL as described later. The first cushion component 101 is in contact with and supported by the support member 105.

The second cushion component 102 is made of a urethane foam that is less deformable than the first cushion component 101. The second cushion component 102 comes into contact with the first cushion component 101 and reduces deformation of the first cushion component 101.

Examples of methods for measuring the resistance to deformation of the first cushion component 101 and second cushion component 102 include a hardness test method A included in test methods prescribed in JIS (Japanese Industrial Standards) K6400-2: 2012 (test methods for flexible cellular polymeric materials).

The second cushion component 102 forms a user side part of the base component 100A as well as the bulge component 100B. Part of the second cushion component 102 is located between the first user side surface F11 and the first cushion component 101.

The second cushion component 102 has a recess 102A formed thereon, and configured such that the first cushion component 101 fits into the recess 102A. The second cushion component 102 has a slit-shaped tear line TL that allows an airbag to deploy frontward from the airbag device AB. The second cushion component 102 is in contact with and supported by the support member 105 and the corresponding side frame SF.

The airbag device AB includes the airbag that is allowed to be deployed outward from the seat cushion C, and an inflator for supplying gas to the airbag. The airbag device AB is fixed to the corresponding side frame SF.

The bags 109 are configured to inflate or deflate in the seat cushion C by injection or release of air into or from the bags. Each of the bags 109 is switchable between a first state shown in FIG. 20(a) and a second state shown in FIG. 20(b). The second state is a different state from the first state. In the first state, the bags 109 are deflated in the first state, and inflated in the second state. When the bags 109 are in the second state, the first user side surface F11 and the second user side surface F12 bulge out toward the user.

The bags 109 are positioned to avoid (i.e., be away from) the first cushion component 101. The bags 109 are located within the second cushion component 102.

The base component 100A contains two or more of the bags 109 therein. Each of the bulge components 100B contains a single one of the bags 109. While a single bag is provided within the base component in this case, two or more bags may be provided at different positions in each bulge component.

The bags 109 in the base component 100A are located near the first user side surface F11. More specifically, the distances between the bags 109 and the first user side surface F11 are smaller than the distance from the bag 109 to the first cushion component 101.

The bag 109 in the bulge component 100B is located near the second user side surface F12. More specifically, the distance between the bag 109 and the second user side surface F12 is smaller than the distance from the bag 109 to the surface of the seat cushion C on the opposite side to the user.

The vehicle seat S of the eighth embodiment achieves the following technical effects. First, in this configuration, the bags 109 are positioned to avoid (i.e., be away from) the first cushion component 101, which prevents significant deformation of the first cushion component 101 made of biomass urethane.

In this configuration, the bags 109 are located and thus movable within the second cushion component 102, which prevents significant deformation of the first cushion component 101.

In this configuration, the second cushion component 102 reduces the deformation of the first cushion component 101 made of biomass urethane, which prevents significant deformation of the first cushion component 101.

In this configuration, the first cushion component 101 is positioned to avoid the user side surface of the bulge component 100B; that is, positioned such that boundaries of the first cushion component do not touch the user side surface of the bulge component 100B, which tends to receive large loads caused by the user's weight. As a result, the force applied to the user side surface of the bulge components is less likely to be transmitted to the first cushion component 101, which effectively reduces deformation of the first cushion component 101.

In this configuration, the first cushion component 101 is positioned to avoid the connection part CN; that is, positioned such that boundaries of the first cushion component do not touch the connection part CN, where stress tends to concentrate. As a result, the stress applied to the connection part CN is less likely to be transmitted to the first cushion component 101, which further reduces deformation of the first cushion component 101.

In this configuration, the first cushion component 101 is positioned away from the airbag device AB, which reduces deformation of the first cushion component 101 even when the operation of the airbag device AB causes a force which is applied to the seat cushion C. In addition, the first cushion component 101 does not have a tear line TL, which further reduces deformation of the first cushion component 101.

The above-described embodiments (in particular, the eighth embodiment) are non-limiting, and the configurations of these embodiments can be applied to other embodiments described below. In the following description, the same features or elements as those of the above described embodiments are denoted with same reference numerals without repeating the description thereof.

### Ninth Embodiment

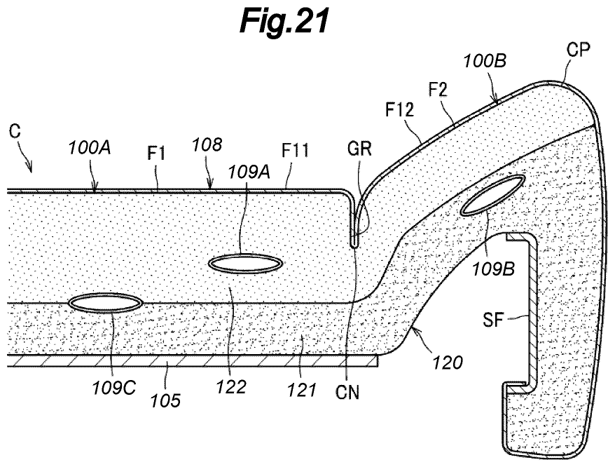

As shown in FIG. 21, a pad body 120 according to a ninth embodiment of the present invention includes a second cushion component 122 on the user side and a first cushion component 121 on the opposite side to the user.

The second cushion component 122 has the first support surface F1, the second support surface F2, the draw-in groove GR and the connection part CN, which are described above. A part of the second cushion component 122 which forms the base component 100A is located between the first user side surface F11 and the first cushion component 121. A part of the second cushion component 122 that forms the bulge component 100B is located between the second user side surface F12 and the first cushion component 121.

The first cushion component 121 is in contact with and thus supported by the support member 105 and side frame SF. The first cushion component 121 is positioned to avoid the connection part CN. The first cushion component 121 is positioned to avoid the second support surface F2. The first cushion component 121 is positioned to avoid a corner portion CP of the corresponding bulge component 100B.

The pad body 120 of the ninth embodiment includes a bag 109A located within the second cushion component 122, a bag 109B located within the first cushion component 121, and a bag 109C sandwiched between the first cushion component 121 and the second cushion component 122.

The pad body 120 of the ninth embodiment achieves the following technical effects. First, in this configuration, the first cushion component 121 is positioned to avoid the connection part CN, where stress tends to concentrate. As a result, the stress applied to the connection part CN is less likely to be transmitted to the first cushion component 121, which further reduces deformation of the first cushion component 121.

In this configuration, the first cushion component 121 is positioned to avoid the second support surface F2, i.e., the user side surface of the bulge component 100B, which tends to receive large loads caused by the user's weight. As a result, the force applied to the second support surface F2 is less likely to be transmitted to the first cushion component 121, which effectively reduces deformation of the first cushion component 121

### Tenth Embodiment

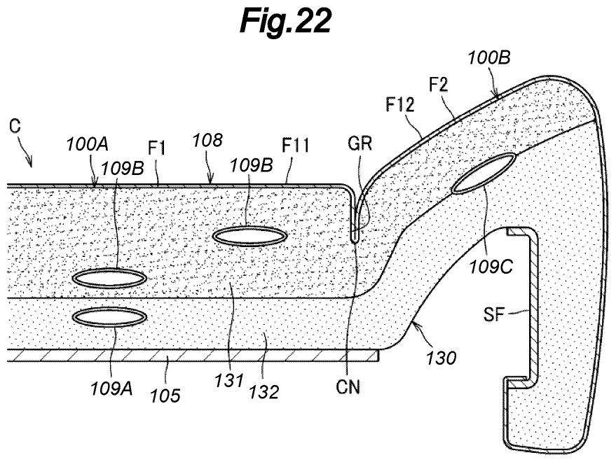

As shown in FIG. 22, a pad body 130 according to a tenth embodiment of the present invention includes a first cushion component 131 on the user side and a second cushion component 132 on the opposite side to the user, in contrast to the ninth embodiment.

The first cushion component 131 has the first support surface F1, the second support surface F2, the draw-in groove GR and the connection part CN, which are described above. A part of the first cushion component 131 which forms the base component 100A is located between the first user side surface F11 and the second cushion component 132. A part of the first cushion component 131 which forms the bulge component 100B is located between the second user side surface F12 and the second cushion component 132.

The second cushion component 132 is located at a position farthest from the user among the components that form the pad body 100. The second cushion component 132 is in contact with and supported by the support member 105 and side frame SF.

The pad body 130 of the tenth embodiment includes a bag 109A located within the second cushion component 132, bags 109B located within the first cushion component 131, and a bag 109C sandwiched between the first cushion component 131 and the second cushion component 132.

### Eleventh Embodiment

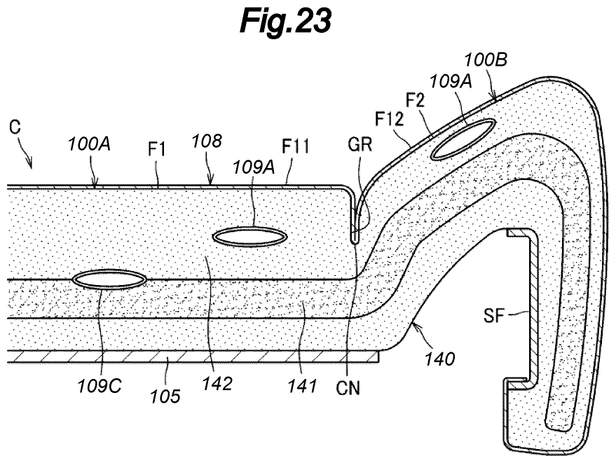

As shown in FIG. 23, a pad body 140 according to an eleventh embodiment of the present invention includes a first cushion component 141 and a second cushion component 142 which are different from those of the eighth embodiment in their shapes. In this embodiment, the second cushion component 142 covers the entire surface of the first cushion component 141. The first cushion component 141 is covered by the second cushion component 142, and thus away from the entire outer surface of the pad body 140 with the second cushion component 142 therebetween.

The second cushion component 142 has the first support surface F1, the second support surface F2, the draw-in groove GR and the connection part CN, which are described above. The second cushion component 142 is in contact with and supported by the support member 105 and side frame SF.

The pad body 140 of the ninth embodiment includes bags 109A located within the second cushion component 142, and a bag 109C sandwiched between the first cushion component 121 and the second cushion component 122.

The pad body 140 of the eleventh embodiment achieves the following technical effects. First, in this configuration, even when a load is applied to any position of the surface of the seat cushion C, the stress applied to the seat cushion is less likely to be transmitted to the first cushion component 141, which further reduces deformation of the first cushion component 141. In addition, this configuration prevents the first cushion component 141 from being deteriorated due to oxygen and moisture.

### Twelfth Embodiment

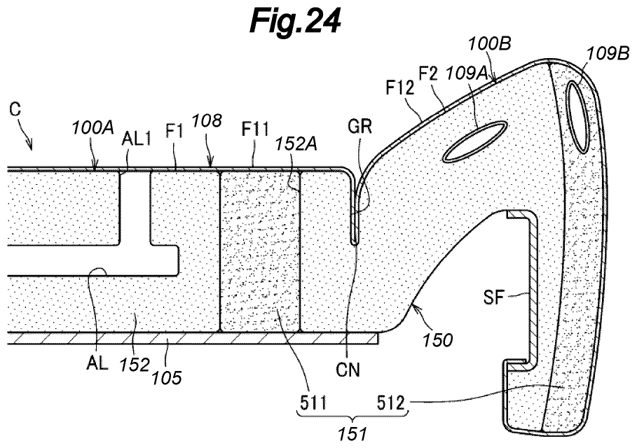

As shown in FIG. 24, a pad body 150 according to a twelfth embodiment of the present invention includes a first cushion component 151 and a second cushion component 152 which are different from those of the eighth embodiment in their shapes. In this embodiment, the second cushion component 152 forms a majority of the pad body 150, and the remaining part of the pad body 150 is partially formed by the first cushion component 151.

The second cushion component 152 further includes an air passage AL through which air flow, in addition to the majority of the first support surface F1, the second support surface F2, the draw-in groove GR and the connection part CN, which are described above. The air passage AL has a first opening AL1 which opens on the user-side surface of the pad body 150, i.e., the first support surface F1, and also has a second opening (not shown) which opens on the side of the pad body 150 opposite the user. The second opening (not shown) is connected, via a duct or any suitable device, to a blower which can blow and draw-in air. The second cushion component 152 comes into contact with and is supported by the support member 105 and side frame SF.

The first cushion component 151 consists primarily of a first component 511 and a second component 512 that form a part of the base component 100A and a part of the bulge component 100B, respectively. The first component 511 and the second component 512 are provided away from the air passage AL. In other words, the first cushion component 151 is configured to have no air passage AL therein.

Specifically, the first component 511 is provided between the air passage AL and the draw-in groove GR in the left-right direction. The first component 511 is inserted into a through hole 152A formed in the second cushion component 152. The through hole 152A extends through the second cushion component 152 in a direction orthogonal to the first support surface F1. The first component 511 is in contact with the skin cover 108 and the support member 105.

The second component 512 is positioned on the outer side surface of the second cushion component 152 in the left-right direction. The second cushion component 152 partially extends between the second component 512 and the side frame SF.

The pad body 150 of the twentieth embodiment has a bag 109A embedded within the second cushion component 152 and a bag 109B embedded within the second component 512.

The pad body of the twelfth embodiment achieves the following technical effects. In this configuration, even when deformation occurs a passage-embedded portion of the seat cushion C where the air passage AL is formed and deformation is likely to occur, the first cushion component 151 is less likely to be affected by the deformation of the passage-embedded, which further reduces deformation of the first cushion component 151.

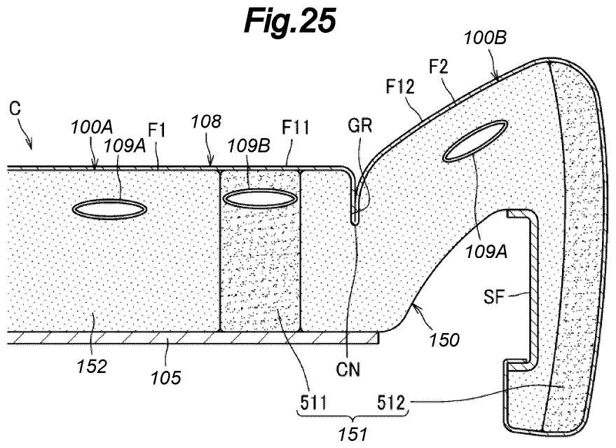

In other cases, as shown in FIG. 25, the pad body of the twelfth embodiment may be configured to have no air passage AL. Even when the first cushion component 151 is provided at positions as shown in FIGS. 24 and 25, the first cushion component 151 is positioned to avoid the connection part CN and the second support surface F2 in a similar manner as the ninth embodiment as in the ninth embodiment.

The pad body 150 as shown in FIG. 25 has bags 109A embedded within the second cushion component 152 and a bag 109B embedded within the first component 511.

### Thirteenth Embodiment

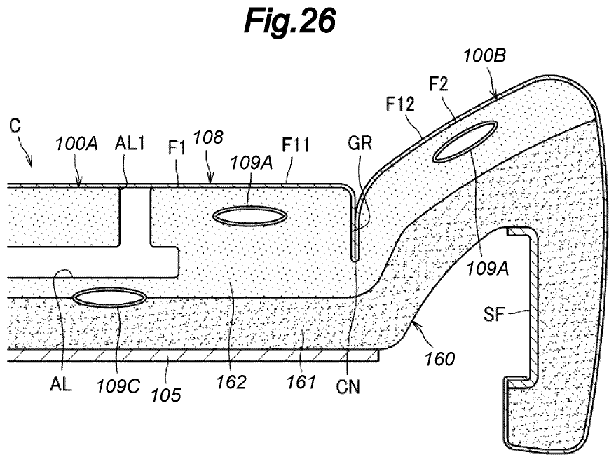

As shown in FIG. 26, a pad body 160 of a thirteenth embodiment of the present invention includes a first cushion component 161 having a similar structure to the first cushion component 121 of the nineteenth embodiment, and a second cushion component 162 having an air passage AL formed in the second cushion component 122 of the nineteenth embodiment. In the thirteenth embodiment, the first cushion component 161 is away from the air passage AL in a similar manner. Though not shown in the drawings, the first cushion component 161 is also away from the second opening, which is on the side of the second cushion component 162 opposite to the user. The pad body 160 of the thirteenth embodiment can achieve the same technical effect as the pad body 150 of the twelfth embodiment.

The pad body 160 of the thirteenth embodiment has bags 109A located within the second cushion component 162 and a bag 109C sandwiched between the first cushion component 161 and the second cushion component 162.

### Fourteenth Embodiment

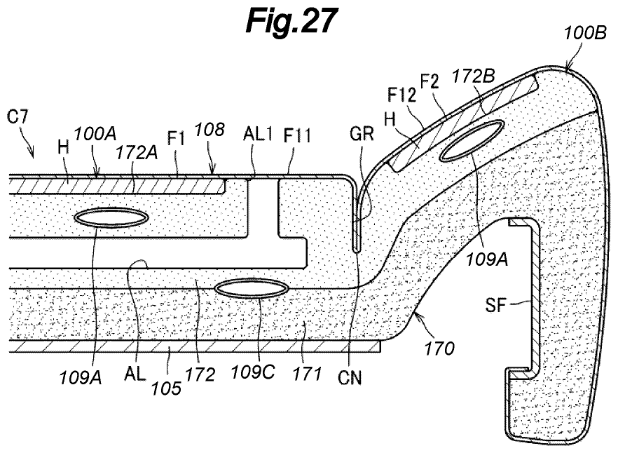

As shown in FIG. 27, a seat cushion C7 of the fourteenth embodiment of the present invention further includes heaters H. Each of the heaters H is a sheet-shaped planar heating element. A pad body 170 of the fourteenth embodiment has a first cushion component 171 having a similar structure to that of the first cushion component 161 of the thirteenth embodiment, and a second cushion component 172 having recesses 172A and 172B formed in the second cushion component 162 of the thirteenth embodiment.

The recesses 172A and 172B are formed so that the heaters H (planar heating elements) are inserted therein. The recess 172A is formed in the first support surface F1 of the second cushion component 172. The recess 172B is formed in the second support surface F2 of the second cushion component 172.

The heaters H are positioned between the skin cover 108 and the second cushion component 172. The user side surface of the heater H in the recess 172A is flush with the first support surface F1. The user side surface of the heater H in the recess 172B is flush with the second support surface F2.

The first cushion component 171 is away from the heaters H. A part of the second cushion component 172 and a part of the air passage AL are located between the heater H in the base component 100A and the first cushion component 171. Another part of the second cushion component 172 is located between the heater H in the bulge component 100B and the first cushion component 171. The first opening AL1 of the air passage AL is located between the recess 172A and the draw-in groove GR.

The pad body 170 of the fourteenth embodiment has bags 109A located within the second cushion component 172 and a bag 109C sandwiched between the first cushion component 171 and the second cushion component 172.

In the seat cushion C7 of the fourteenth embodiment, the first cushion component 171 is away from the heaters H and thus heat from the heaters H is less likely to be transferred to the first cushion component 171, which means that the first cushion component 171 is less affected by the heat from the heaters H. In addition, the air passage AL is partially located between the heater H and the first cushion component 171, which further prevents the first cushion component 171 from being affected by the heat from heater H.

### Fifteenth Embodiment

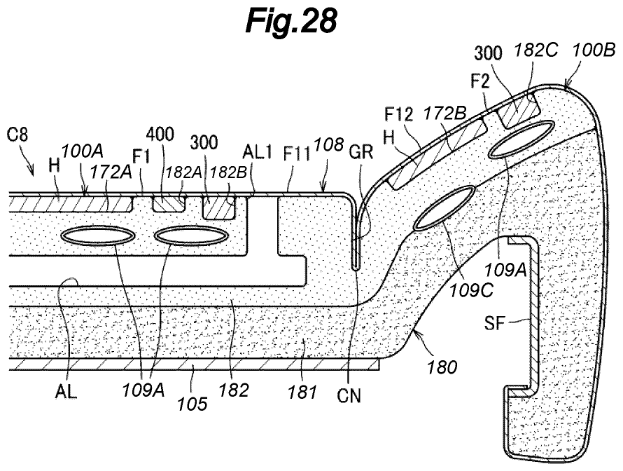

As shown in FIG. 28, a seat cushion C8 of the fifteenth embodiment further includes a notifying device 300 for providing a notification to a user and a sensor 400 for acquiring the user's physical information. The notifying device 300 generates vibration, sound, light or any other signal to provide a notification to the user. The sensor 400 is, for example, a pressure sensor that detects pressure caused by the user's weight. The sensor 400 may also be a seating sensor, a pulse wave sensor, or a blood pressure sensor.

Pressure values detected by the sensor 400 are provided to a controller (not shown). The controller, for example, transmits the pressure values to a mobile terminal carried by a user. The mobile terminal, for example, outputs instructions to move a user's body on the vehicle seat S. When the user moves their body on the vehicle seat S, the mobile terminal executes an application program, such as a game, based on the pressure values caused by the corresponding body movements. When providing a notification to a user is necessary during the application program, the mobile terminal outputs a notification signal to the controller. When receiving the notification signal, the controller activates the notifying device 300 to provide a notification.

The pad body 180 of the fifteenth embodiment has a first cushion component 181 having a similar structure to that of the first cushion component 171 of the fourteenth embodiment, and a second cushion component 182 having recesses 182A, 182B, and 182C formed in the second cushion component 172 of the fourteenth embodiment. The recess 182A is formed so that the sensor 400 fits therein. Each of the recesses 182B and 182C is formed so that the notifying device 300 fits therein.

The recesses 182A and 182B are formed on the first support surface F1 of the second cushion component 182. The recess 182C is formed on the second support surface F2 of the second cushion component 182. The recess 182A is located between the recesses 172A and 182B. The recess 182B is located between the recess 182A and the draw-in groove GR. The recess 182C is located transversely outward of the recess 172B.

The sensor 400 and the notifying device 300 are positioned between the skin cover 108 and the second cushion component 182. The user side surface of the sensor 400 in the recess 182A and the user side surface of the notifying device 300 in the recess 182B are flush with the first support surface F1. The user side surface of the notifying device 300 in the recess 182C is flush with the second support surface F2.

The first cushion component 181 is away from the notifying device 300. The first cushion component 181 is away from the sensor 400. A part of the second cushion component 182 and a part of the air passage AL are located between the notifying device 300 on the base component 100A and the first cushion component 181. A part of the second cushion component 182 and a part of the air passage AL are located between the sensor 400 and the first cushion component 181. A part of the second cushion component 182 is located between the notifying device 300 in the bulge component 100B and the first cushion component 181.

The pad body 180 of the fifteenth embodiment has bags 109A located within the second cushion component 182 and a bag 109C sandwiched between the first cushion component 181 and the second cushion component 182.

In the seat cushion C8 of the fifteenth embodiment, the first cushion component 181 is away from the notifying device 300 and the sensor 400 and thus heat from the notifying device 300 and the sensor 400 is less likely to be transferred to the first cushion component 181, which means that the first cushion component 181 is less affected by the heat from t the notifying device 300 and the sensor 400.

### Sixteenth Embodiment

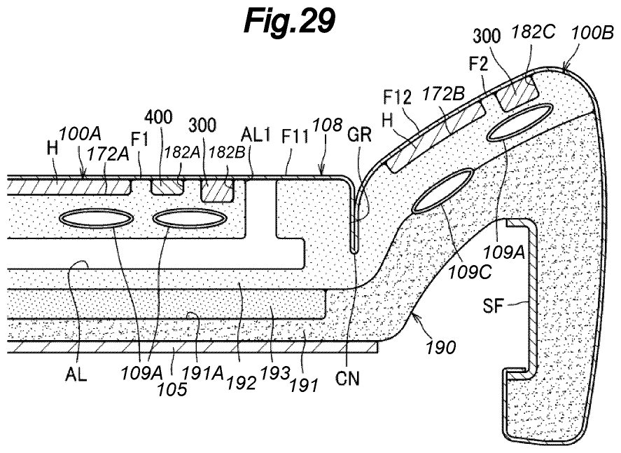

As shown in FIG. 29, a pad body 190 of a sixteenth embodiment of the present invention has a third cushion component 193, in addition to a first cushion component 191 and a second cushion component 192. The first cushion component 191 and second cushion component 192 are the substantially same as those of the fifteenth embodiment.

The first cushion component 191 has a recess 191A on its surface facing the second cushion component 192. The recess 191A is located within the base component 100A.

The third cushion component 193 is made of urethane foam that is less deformable than the second cushion component 192. A test method for measuring the resistance to deformation of the material may be the same as the test described above with regard to the eighth embodiment.

The third cushion component 193 is placed into the recess 191A. The user side surface of the third cushion component 193 in the recess 191A is flush with the user side surface of the first cushion component 191. The third cushion component 193 is sandwiched between the first cushion component 191 and the second cushion component 192. The third cushion component 193 is positioned between the left and right draw-in grooves GR. The cushion component 193 is transversely away from the left and right draw-in grooves GR.

The air passage AL is positioned within a range of the third cushion component 193 in the left-right direction. The heater H, notifying device 300, and sensor 400 located on the base component 100A are positioned within the range of the third cushion component 193 in the left-right direction.

The pad body 190 of the sixteenth embodiment has bags 109A located within the second cushion component 192 and a bag 109C sandwiched between the first cushion component 191 and the second cushion component 192.

In the pad body 190 of the sixteenth embodiment, the third cushion component 193, which is less deformable than the second cushion component 192, supports part of the first cushion component 191, which effectively reduces deformation of the first cushion component 191.

### Seventeenth Embodiment

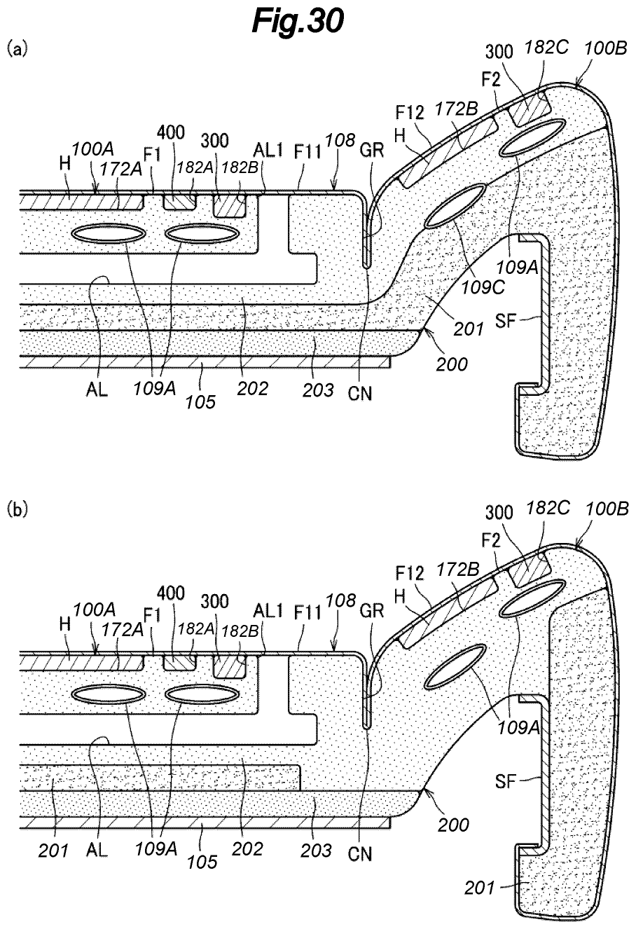

As shown in FIG. 30(A), a pad body 200 of a seventeenth embodiment is different from that of the sixteenth embodiment in the position of the third cushion component 203. The first cushion component 201 of the seventeenth embodiment includes a corresponding part to the base component 100A having a thickness that is smaller than that of the fifteenth embodiment. The second cushion component 202 of the seventeenth embodiment is substantially the same as that of the fifteenth embodiment. A part of the first cushion component 201 (i.e., a part forming the base component 100A) is positioned between the second cushion component 202 and the third cushion component 203.

The third cushion component 203 is positioned between the first cushion component 201 and the support member 105. The third cushion component 203 contacts the first cushion component 201 and the support member 105. The left and right draw-in grooves GR are positioned within a range of the third cushion component 203 in the left-right direction.

The pad body 200 of the seventeenth embodiment can achieve the same technical effect as the pad body 190 of the sixteenth embodiment. In the pad body 200 of the seventeenth embodiment, the third cushion component 203 supports the first cushion component 201 over a wider range in the left-right direction than that of the sixteenth embodiment, which effectively reduces deformation of the first cushion component 201.

The pad body 200 of the seventeenth embodiment includes bags 109A located within the second cushion component 202 and a bag 109C sandwiched between the first cushion component 201 and the second cushion component 202. In other cases, as shown in FIG. 30(B), the ratio of the second cushion component 202 to the whole bulge component 100B may be greater than that of the embodiment of FIG. 30(A). In this case, the pad body 200 may only have the bags 109A located within the second cushion component 202.

### Eighteenth Embodiment

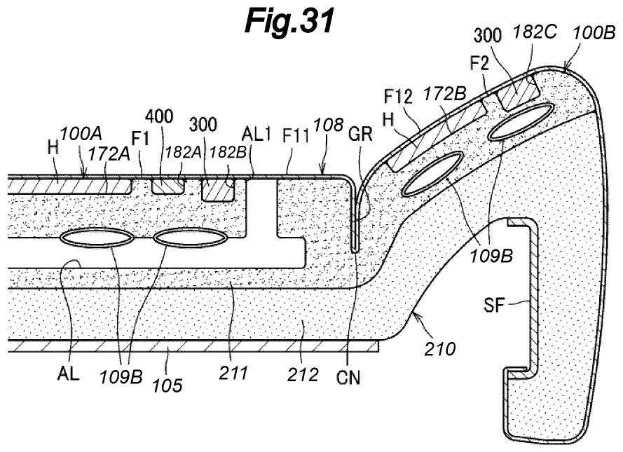

A pad body 210 of an eighteenth embodiment as a reference example of the pad body will be described. As shown in FIG. 31, the pad body 210 of the eighteenth embodiment includes a first cushion component 211 on the user side and a second cushion component 212 on the side opposite the user, in which the first and second cushion components are positioned reverse of the pad body of the fifteenth embodiment.

The first cushion component 211 has a substantially same structure as the second cushion component 182 of the fifteenth embodiment. The first cushion component 211 has the first support surface F1, second support surface F2, draw-in groove GR, connection part CN, air passage AL, and recesses 172A, 172B, 182A to 182C, as described above. The first cushion component 211 contacts the heater H, the notifying device 300, and the sensor 400.

The second cushion component 212 has a substantially same structure as the first cushion component 181 of the fifteenth embodiment. The second cushion component 212 is in contact with and supported by the support member 105 and side frame SF.

The pad body 210 of the eighteenth embodiment has bags 109B located within the first cushion component 211. The bags 109B may be located within the air passage AL.

In the pad body 210 of the eighteenth embodiment, the first cushion component 211 is supported by the second cushion component 212, which can reduce deformation of the first cushion component 211.

### Nineteenth Embodiment

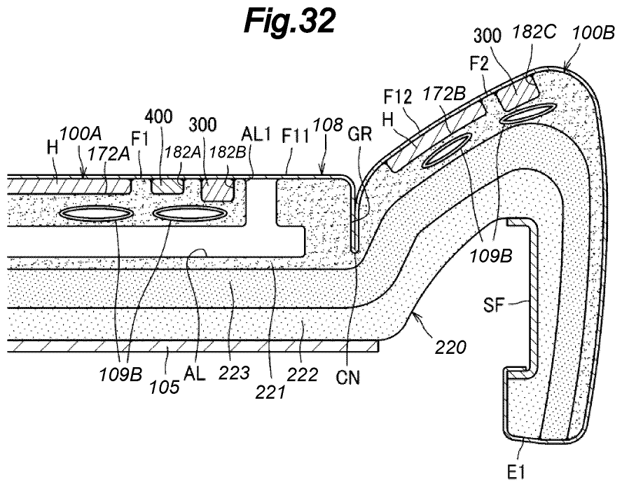

A pad body 220 of a nineteenth embodiment as a reference example of the pad body will be described. As shown in FIG. 32, the pad body 220 of the nineteenth embodiment includes, in addition to a first cushion component 221 and a second cushion component 222, each having the same structure as that of the eighteenth embodiment, a third cushion component 223 that is less deformable than the second cushion component 222. The third cushion component 223 is positioned between the first cushion component 221 and the second cushion component 222.

The third cushion component 223 partially forms the base component 100A and the bulge component 100B. The third cushion component 223 has a cross section taken along a line perpendicular to the first support surface F1 and a line in the left-right direction (hereinafter also referred to as a “transverse cross-section”), the cross section extending continuously from one end E1 to the other end (not shown) of the pad body 220. Similarly, the first cushion component 221 and second cushion component 222 also have respective cross sections extending continuously from one end E1 to the other end (not shown) of the pad body 220.

The pad body 220 of the nineteenth embodiment has bags 109B located within the first cushion component 221.

In the pad body 220 of the nineteenth embodiment, the first cushion component 221 is supported from one end to the other end by the third cushion component 223, which can further reduce deformation of the first cushion component 221.

### Twentieth Embodiment

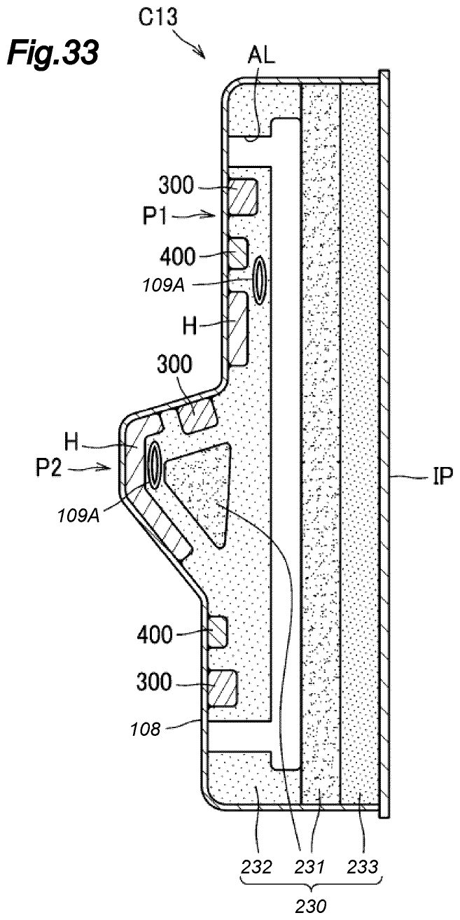

As shown in FIG. 33, a seat cushion C13 of a twentieth embodiment of the present embodiment is attached to an inner panel IP that forms a vehicle door. The door includes the inner panel IP and a metal outer panel.

The seat cushion C13 has a first portion P1 that forms a door lining and a second portion P2 that forms an armrest. The second portion P2 protrudes from the user side surface of the first portion P1. The seat cushion C13 has a skin cover 108, a heater H, a notifying device 300, a sensor 400, an air passage AL, and a pad body 230.

The pad body 230 has two first cushion components 231, a second cushion component 232, and a third cushion component 233. The second cushion component 232 has an air passage AL and a plurality of recesses such that the heater H, the notifying device 300, and the sensor 400 can be placed in the corresponding recesses. The air passage AL is formed as a groove that opens transversely outward. Part of the second cushion component 232 protrudes inward toward a seated user, forming an armrest. The skin cover 108 is attached to the user side surface of the second cushion component 232.

One of the two first cushion components 231, which is an outer first cushion component, forms part of the first portion P1 (door lining), and the other, which is an inner first cushion component, partially forms the second portion P2 (armrest). The outer first cushion component 231 is located between the second cushion component 232 and the third cushion component 233. The outer first cushion component 231 covers an opening of a grooved air passage AL, thereby defining part of the air passage AL.

The inner first cushion component 231 is located within the part of the second cushion component 232 that forms the armrest. The entire surface of the inner first cushion component 231 is covered by the second cushion component 232. Both the inner and outer first cushion components 231 are away from the heater H, the notifying device 300 and the sensor 400. The third cushion component 233 is in contact with and is supported by the inner panel IP.

The pad body 230 of the twentieth embodiment has bags 109A located within the second cushion component 232.

In the seat cushion C13 of the twentieth embodiment, the first cushion component 231 is sandwiched between and supported by the second cushion component 232 and the third cushion component 233, which can reduce deformation of the first cushion component 231. In addition, the first cushion component 231 only needs to at least partially extend between the second cushion component and the third cushion component.

### Twenty-First Embodiment

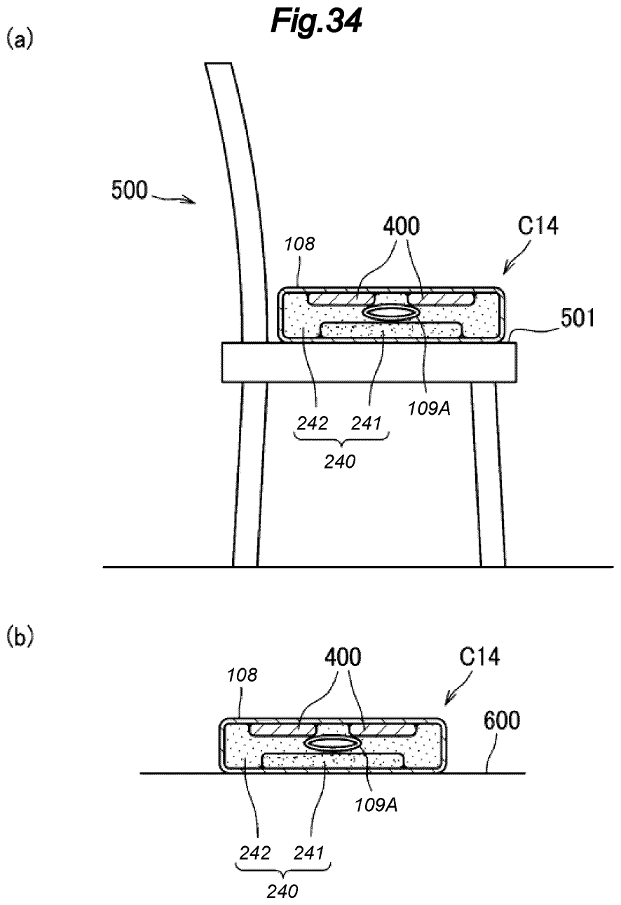

As shown in FIG. 34(A) and 34(B), a seat cushion C14 of a twenty-first embodiment of the present invention is attached to a seat 501 of a chair 500 or placed on a floor 600 so that the seat cushion C14 is used as a seat cushion for a vehicle. The seat cushion C14 has a skin cover 108, sensors 400, and a pad body 240.

The seat cushion C14 is provided with a controller (not shown). The controller is configured to provide a pressure value from each of the sensors 400 to a mobile terminal in the same manner as in the fifteenth embodiment.

The pad body 240 includes a first cushion component 241 and a second cushion component 242. The second cushion component 242 has a plurality of recesses such that the sensors 400 and the first cushion component 241 can be placed in the corresponding recesses.

The sensors 400 are located on the user side surface of the second cushion component 242. The first cushion component 241 is located on the surface of the second cushion component 242 opposite the user. The first cushion component 241 is away from the sensors 400. The skin cover 108 covers an entire surface of the second cushion component 242.

The pad body 240 of the twenty-first embodiment has a bag 109A located within the second cushion component 242.

In the pad body 240 of the twenty-first embodiment, the first cushion component 241 is away from the sensors 400, which prevents transfer of heat from the sensors 400 to the first cushion component 241.

### Twenty-Second Embodiment

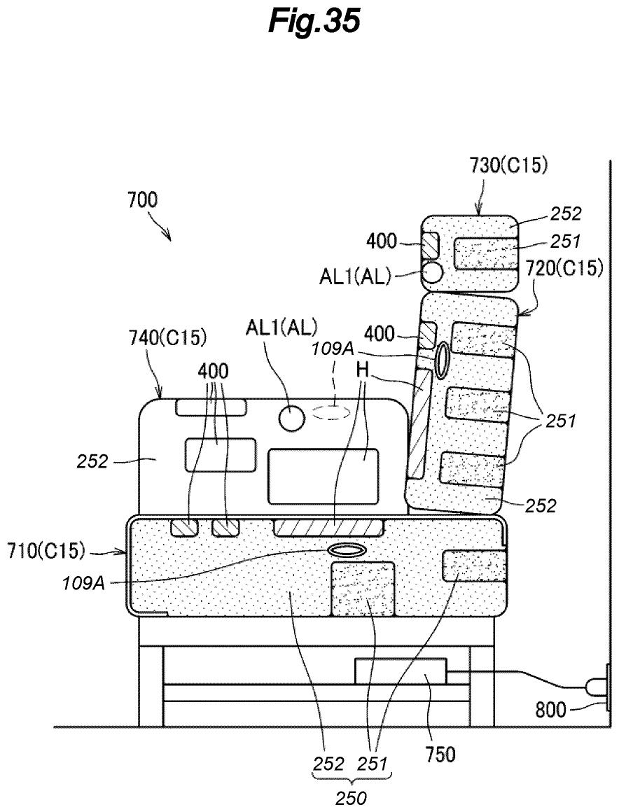

As shown in FIG. 35, a sofa 700 is formed by seat cushions C15 of a twenty-second embodiment. The sofa 700 includes a bottom seat cushion 710, a seat back 720, a headrest 730, armrests 740, and a controller 750. The armrests 740 are provided on both left and right sides of the bottom seat cushion 710. For the purpose of clarity, a skin cover is not shown in FIG. 35.

Each of the seat cushions C15 (hereafter also referred to as “the seat cushion C15”) has at least one of a heater H, a sensor(s) 400, and an air passage AL, as well as a pad body 250 and a skin cover (not shown) that covers an entire surface of the pad body 250. The pad body 250 has at least one first cushion component 251 and a second cushion component 252. The first cushion component 251 is away from the heater H, sensor(s) 400 and air passage AL. The heater H, the sensor(s) 140 and a first opening AL1 of the air passage AL are positioned on the user side surface of the pad body 250.

Specifically, the seat cushion C15 forming the bottom seat cushion 710 has a heater H and a plurality of sensors 400. The plurality of sensors 400 are located in a front part of the pad body 250. The number of sensors 400 may be four in total such that, for example, a pair of sensors 400 are arranged in a raw in the front-rear direction on each of the left and right sides of the bottom seat cushion 710. The heater H is located rearward of the sensors 400.

The seat cushion C15 that forms the bottom seat cushion 710 has two first cushion components 251. One of the first cushion components 251 (underside first cushion component) is located on the side of the pad body 250 facing downward opposite the user. The rear end of the heater H is positioned within a range of the underside first cushion component 251 in the front-rear direction. The front end of the underside first cushion components 251 is positioned within a range of the heater H in the front-rear direction.

The other of the first cushion components 251, which is a rear side first cushion component, is located on the rear side of the pad body 250. The rear side first cushion component 251 is away from the upper and lower surfaces of the pad body 250.

The seat cushion C15 that forms the seat back 720 has a heater H and a sensor 400. The sensor 400 is located upward of the heater H. One sensor 400 may be provided on each of the left and right parts of the seat back 720.

The seat cushion C15 that forms the seat back 720 includes three first cushion components 251. The three first cushion components 251 are arranged in a row in the vertical direction with a gap therebetween. The sensor 400 is at least partially located within a range of the upper first cushion component 251 in the vertical direction. The middle cushion component 251 is located within a range of the heater H in the vertical direction. The lower cushion component 251 is at least partially located within a range of the heater H in the vertical direction.

The seat cushion C15 that forms the headrest 730 has a sensor 400 and an air passage AL. The sensor 400 is located above a first opening AL1 of the air passage AL. The sensor 400 is at least partially located within a range of the first cushion component 251 in the vertical direction. The first opening AL1 is at least partially located within a range of the first cushion component 251 in the vertical direction.

The seat cushion C15 that forms each of the armrests 740 has a heater H, sensors 400, and an air passage AL. The heater H is located in a lower rear part of the armrest 740. The sensors 400 are located frontward of the heater H. The two sensors 400 are provided in an upper part and a vertically middle part of the armrest 740. The air passage AL has a first opening AL1 located above the heater H. The seat cushion C15 that forms the armrest 740 has a first cushion component 251 (not shown) provided therein.

The controller 750 controls the heater H and acquires information from the sensors 400. The controller 750 can be connected to a utility power source 800 provided on a wall of the building or any other place.

The pad body 250 of the twenty-second embodiment has a bag 109A located within the second cushion component 252.

In the seat cushions C15 of the twenty-second embodiment, the first cushion component 251 is away from the sensor 400 or other heat generation components, which prevents transfer of heat from the sensors 400 or other components to the first cushion component 251.

### Twenty-Third Embodiment

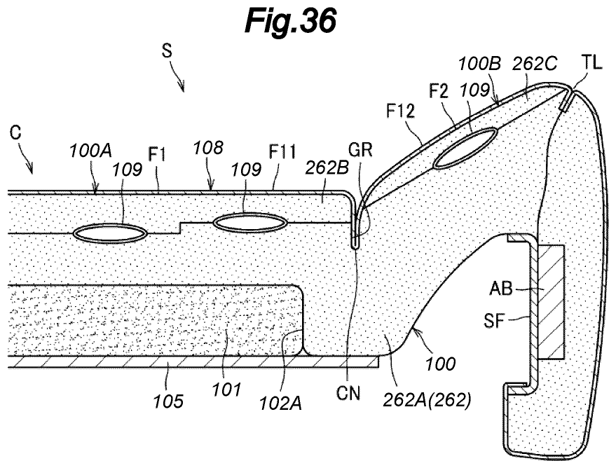

As shown in FIG. 36, a second cushion component 262 of a twenty-third embodiment of the present invention consists of a plurality of members, which are formed by the division of the second cushion component 262 of the eighth embodiment into three pieces. The second cushion component 262 comprises a first member 262A, a second member 262B, and a third member 262C.

The first member 262A forms a portion of the second cushion component 262 that is opposite to a user. The first member 262A has the above-described recess 102A. The first member 262A is in contact with and supported by the support member 105 and the side frame SF.

The second member 262B forms a user side portion of the base component 100A of the second cushion component 262. The second member 262B is provided such that a plurality of bags 109 are sandwiched between the first member 262A and the second member 262B. As shown in the drawings, when the plurality of bags 109 provided within the base component 100A are located at different positions along a direction orthogonal to the first user side surface F11, the first member 262A has a contact surface which is in contact with the second member 262B, and which may be formed in e.g., a stepped manner.

The surface of the first member 262A facing the second member 262B may have a recess for the bag 109, or may not. Similarly, the surface of the second member 262B facing the first member 262A may have a recess for the bag 109, or may not.

The third member 262C forms a user side portion of the bulge component 100B of the second cushion component 262. The third member 262C is provided such that a bag 109 is sandwiched between the first member 262A and the third member 262C. The surface of the first member 262A facing the third member 262C may have a recess for the bag 109 or may not. Similarly, the surface of the third member 262C facing the first member 262A may have a recess for the bag 109 or may not.

According to the twenty-third embodiment, the second cushion component 262 is configured such that the bags 109 are easily placed in the second cushion component 262. This configuration also allows the bags 109 to be easily removed from the second cushion component 262.

### Twenty-Fourth Embodiment

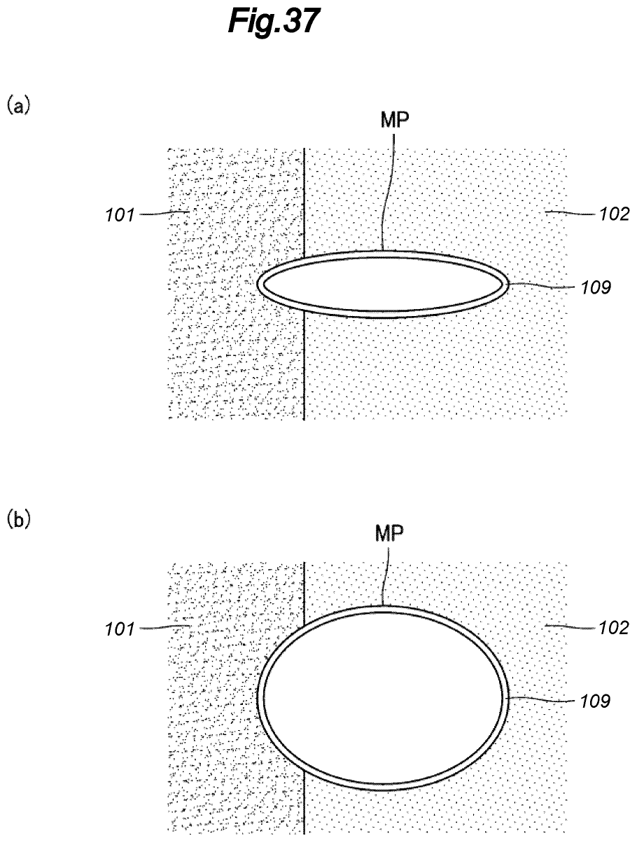

As shown in FIG. 37(A) and 37(B), each bag 109 has a maximum displacement section MP. The maximum displacement section MP is a part of the bag 109 where, when a state of the bag 109 is switched from a first state as shown in FIG. 37(A) to a second state as shown in FIG. 37(B), the amount of displacement is maximized. Any one of the bags 109 described in the above embodiments has such a maximum displacement section MP.

According to a twenty-fourth embodiment, each of the bags 109 is provided such that the maximum displacement section MP of the bag 109 is positioned to avoid the first cushion component 101. Specifically, the bag 109 is provided such that a part of the bag 109 is located within the first cushion component 101, and another part of the bag 109 is located within the second cushion component 102. The maximum displacement section MP is located within the second cushion component 102.

According to the twenty-fourth embodiment, the maximum displacement section MP of each of the bags 109 is positioned to avoid the first cushion component 101, which prevents significant deformation of the first cushion component 101 made of biomass urethane.

A component configured to contact the first cushion component to reduce the deformation thereof (hereinafter also referred to as “deformation prevention component”) is not limited to the second cushion component. While the deformation prevention component may be a material that is more likely to be deformed than the first cushion component, the deformation prevention component is preferably less deformable than the first cushion component. Examples of materials that are less deformable than the first cushion component include a plate-shaped and rod-shaped members made of metal or plastics.

A cushion component of the present invention may be configured such that a cushion component does not include a skin cover. For example, a cushion component may be comprised only of a pad body. Cushion components may form interior parts of a vehicle, other than door linings.

The first cushion component may be configured such that a proportion of plant-derived material contained therein is greater than or equal to a first predetermined value (e.g., 35%). The second cushion component may be configured such that a proportion of plant-derived material contained therein, which is less than or equal to a second predetermined value (e.g., 15%).

Any component that moves (having at least a part where the position or shape is changeable) within the seat cushion may be used as the movable component, and examples of the movable components may include a support component that can be moved between a first position and a second position that is closer to a user than the first position. When the seat cushion includes a plurality of movable components, all the movable components are preferably positioned to avoid (i.e., to be away from) the first cushion component.

Elements and features of the above-described embodiments may be combined with each other as appropriate to yield another embodiment which is within the scope of the present invention.

### GLOSSARY

1 automobile seat (vehicle seat)
8 seat frame
9 side member
14 support member
18 support side protrusion
21 pad member
22 support surface
29 pad side recess
38 first wire
43 second wire
44 incision
46 through hole
47 pad side protrusion (protrusion)

1. A vehicle seat comprising:
a seat frame that serves as a skeletal frame;
a support member provided on the seat frame and having a support surface facing upward; and
a pad member supported on the support member, the pad member having a contact surface that is in contact with the support surface,
wherein at least one of the support surface of the support member and the contact surface of the pad member has a plurality of protrusions formed thereon and protruding toward the other of the support surface and the contact surface.

2. The vehicle seat as claimed in claim 1, wherein the plurality of protrusions are formed on the support surface of the support member and protrude toward the contact surface of the pad member, and
wherein the contact surface of the pad member has recesses formed thereon that receive the corresponding protrusions.

3. The vehicle seat as claimed in claim 2, wherein the plurality of protrusions extend in a left-right direction of the vehicle seat, and
wherein each of the plurality of protrusions has a first wire embedded therein.

4. The vehicle seat as claimed in claim 3, wherein the seat frame comprises:
left and right side members that are spaced apart from each other; and
a plurality of second wires that extend in the left-right direction and are connected to the left and right side members, and
wherein the contact surface of the pad member has incisions formed thereon to receive the corresponding second wires.

5. The vehicle seat as claimed in claim 1, wherein the plurality of protrusions are formed on the contact surface of the pad member and protrude toward the support member, and
wherein the support member has a plurality of through holes that extend therethrough to receive the plurality of protrusions.

6. The vehicle seat as claimed in claim 2, wherein the plurality of protrusions comprise elongated protrusions extending along the support surface in at least two directions that are different from each other.

7. The vehicle seat as claimed in claim 6, wherein each of the plurality of protrusions has a tapered cross-sectional shape that tapers upward.

8. The vehicle seat as claimed in claim 4, wherein the plurality of protrusions are unevenly provided to be distributed into a part of the support surface of the support member.

9. The vehicle seat as claimed in claim 3, wherein the plurality of protrusions are integrally formed with the corresponding recesses.

10. A method for manufacturing a vehicle seat, wherein the vehicle seat comprises a seat frame that serves as a skeletal frame, a support member provided on the seat frame, and a pad member supported on the support member, and wherein the support member has a plurality of through holes that extend therethrough, the method comprising a step of molding in which the pad member and the support member are molded together as one piece, and
wherein, in the step of molding, parts of the pad member are received in the corresponding through holes formed in the support member.
